(19) United States
(12) Patent Application Publication
(10) Pub. No.: US 2014/0343218 A1
(43) Pub. Date: Nov. 20, 2014

(54) CARBON FIBER

(71) Applicants: Makoto Kibayashi, Decatur, AL (US); Satoshi Seike, Decatur, AL (US); Lawrence A. Pranger, Decatur, AL (US)

(72) Inventors: Makoto Kibayashi, Decatur, AL (US); Satoshi Seike, Decatur, AL (US); Lawrence A. Pranger, Decatur, AL (US)

(73) Assignee: TORAY CARBON FIBERS AMERICA, INC., Decatur, AL (US)

(21) Appl. No.: 14/162,504

(22) Filed: Jan. 23, 2014

Related U.S. Application Data
(63) Continuation-in-part of application No. 13/895,468, filed on May 16, 2013.

(51) Int. Cl. C08K 9/08; B05D 7/24; B05D 7/00; B05D 3/02

(52) U.S. Cl. CPC C08K 9/08; B05D 3/0254; B05D 3/0209; B05D 7/24; B05D 7/00
USPC 524/538; 427/385.5

(57) ABSTRACT

A method of making a carbon fiber structure including a carbon fiber is coated with a sizing at an amount X between 0.05 and 0.30 weight %. The sizing is formed of a heat resistant polymer or a precursor of the heat resistant polymer. The amount X of the sizing is expressed with a following formula:

$$X = \frac{{w}_{0} - {w}_{1}}{{w}_{0}} \times 100$$

where W₀ is a weight of the carbon fiber with the sizing, and W₁ is a weight of the carbon fiber without the sizing.

### CROSS-REFERENCE TO RELATED APPLICATIONS

This application claims priority to U.S. patent application Ser. No. 13/895,468, filed on May 16, 2013 and titled, “Carbon Fiber,” which is a continuation of PCT Application No. PCT/US2011/061088, filed on Nov. 16, 2011, which claims priority to U.S. patent application Ser. No. 12/947,160, filed on Nov. 16, 2010 and titled, “Carbon Fiber”; PCT Application No. PCT/US2013/040946, filed on May 14, 2013, which claims priority to U.S. patent application Ser. No. 13/471,993, filed on May 15, 2012, and titled “Milled Carbon Fiber”; PCT Application No. PCT/US2013/040920, filed on May 14, 2013, which claims priority to U.S. patent application Ser. No. 13/471,885, filed on May 15, 2012, and titled “Chopped Carbon Fiber”; PCT Application No. PCT/US2013/040908, filed on May 14, 2013, which claims priority to U.S. patent application Ser. No. 13/471,850, filed on May 15, 2012, and titled “Carbon Fiber Fabric”; PCT Application No. PCT/US2013/040930, filed on May 14, 2013, which claims priority to U.S. patent application Ser. No. 13/471,957 filed on May 15, 2012 and titled “Carbon Fiber Braid”; PCT Application No. PCT/US2013/034345, filed on Mar. 28, 2013, which claims priority to U.S. patent application Ser. No. 13/432,487, filed on Mar. 28, 2012, and titled “Thermoplastic Molding Preform”; and PCT Application No. PCT/US2012/068145, filed on Dec. 6, 2012, which claims priority to U.S. patent application Ser. No. 13/312,170, filed on Dec. 6, 2011, and titled “Thermoplastic Resin Impregnated Tape”. The contents of the foregoing PCT applications and U.S. patent applications are incorporated herein by reference in their entireties.

### BACKGROUND OF THE INVENTION AND RELATED ART STATEMENT

The present invention relates to a carbon fiber with a sizing capable of achieving superior mechanical property and resistance against thermal degradation.

Carbon fiber reinforced plastics (CFRP) have superior mechanical properties such as high specific strength and high specific modulus; therefore, they are used for a wide variety of applications, e.g., aerospace, sports equipment, industrial goods, and the like. In particular, CFRP with a matrix consisting of a thermoplastic resin has a great advantage such as quick molding characteristics and superior impact strength. In recent years, research and development efforts in this area have been flourishing.

In general, polymer type composite materials tend to show reduced strength and modulus under high temperature conditions. Thereby, heat resistant matrix resins are necessary in order to maintain desired mechanical properties under high temperature conditions. Such heat resistant matrix resins include a thermosetting polyimide resin, a urea-formaldehyde resin, a thermoplastic polyimide resin, a polyamideimide resin, a polyetherimide resin, a polysulfone resin, a polyethersulfone resin, a polyetheretherketone resin, a polyetherketoneketone resin, and a polyphenylenesulfide resin.

CFRP with heat resistant matrix resins are molded under high temperature conditions, so a sizing must withstand thermal degradation. If the sizing experiences thermal degradation, voids and some other problems occur inside a composite, resulting in undesired composite mechanical properties. Accordingly, a heat resistant sizing is an essential part of CFRP for better handleability, superior interfacial adhesive capability, controlling fuzz development, etc.

A conventional heat resistant sizing has been developed and tried in the past. For instance, U.S. Pat. No. 4,394,467 and U.S. Pat. No. 5,401,779 have disclosed a polyamic acid oligomer as an intermediate agent generated from a reaction of an aromatic diamine, an aromatic dianhydride, and an aromatic tetracarboxylic acid diester. When the intermediate agent is applied to a carbon fiber at an amount of 0.3 to 5 weight % (or more desirably 0.5 to 1.3 weight %), it is possible to produce a polyimide coating. However, the sizing amount of 0.3 to 5 weight % does not seem efficient in terms of drape ability and spreadability for resin impregnation. The composite mechanical properties tend to be lower than a desirable level.

In U.S. Pat. No. 5,155,206 and U.S. Pat. No. 5,239,046, a composition of the polyamideimide as the sizing has been disclosed. However, the sizing amount that is essential to reduce harmful volatiles and to obtain the optimal mechanical properties such as tensile strength and adhesive strength between carbon fiber and matrix resin has not been disclosed.

In view of the problems described above, an object of the present invention is to provide a carbon fiber with low generation of harmful volatiles and high mechanical properties such as tensile strength and adhesive strength between carbon fiber and matrix resin in addition to superior resistance to thermal degradation and capability for resin impregnation.

Further objects and advantages of the invention will be apparent from the following description of the invention.

### SUMMARY OF THE INVENTION

In order to attain the objects described above, according to the present invention, a carbon fiber is coated with a sizing at an amount X between 0.05 and 0.30 weight %. The sizing is formed of a heat resistant polymer or a precursor of the heat resistant polymer. The amount X of the sizing is expressed with the following formula:

$$X = \frac{{w}_{0} - {w}_{1}}{{w}_{0}} \times 100$$

where W₀ is a weight of the carbon fiber with the sizing, and W₁ is a weight of the carbon fiber without the sizing.

### BRIEF DESCRIPTION OF THE DRAWINGS

FIG. 1 is a graph showing a relationship between strand tensile strength and sizing amount (KAPTON type polyimide, T800SC-24K, KAPTON is a registered trademark of E. I. du Pont de Nemours and Company);

FIG. 2 is a graph showing a relationship between drape value and sizing amount (KAPTON type polyimide, T800SC-24K)

FIG. 3 is a graph showing a relationship between rubbing fuzz and sizing amount (KAPTON type polyimide, T800SC-24K);

FIG. 4 is a graph showing a relationship between ILSS and sizing amount (KAPTON type polyimide, T800SC-24K);

FIG. 5 is a graph showing a TGA measurement result of T800S type fiber coated with KAPTON type polyimide;

FIG. 6 is a graph showing a TGA measurement result of KAPTON type polyimide;

FIG. 7 is a graph showing a relationship between strand tensile strength and sizing amount (ULTEM type polyetherimide, T800SC-24K, ULTEM is a registered trademark of Saudi Basic Industries Corporation);

FIG. 8 is a graph showing a relationship between drape value and sizing amount (ULTEM type polyetherimide, T800SC-24K);

FIG. 9 is a graph showing a relationship between rubbing fuzz and sizing amount (ULTEM type polyetherimide, T800SC-24K);

FIG. 10 is a graph showing a relationship between ILSS and sizing amount (ULTEM type polyetherimide, T800SC-24K);

FIG. 11 is a graph showing a TGA measurement result of T800S type fiber coated with ULTEM type polyetherimide;

FIG. 12 is a graph showing a TGA measurement result of ULTEM type polyetherimide;

FIG. 13 is a graph showing a relationship between strand tensile strength and sizing amount (ULTEM type polyetherimide, T700SC-12K);

FIG. 14 is a graph showing a relationship between drape value and sizing amount (ULTEM type polyetherimide, T700SC-12K);

FIG. 15 is a graph showing a relationship between rubbing fuzz and sizing amount (ULTEM type polyetherimide, T700SC-12K);

FIG. 16 is a graph showing a relationship between ILSS and sizing amount (ULTEM type polyetherimide, T700SC-12K);

FIG. 17 is a graph showing a relationship between strand tensile strength and sizing amount (Methylated melamine-formaldehyde, T700SC-12K);

FIG. 18 is a graph showing a relationship between drape value and sizing amount (Methylated melamine-formaldehyde, T700SC-12K);

FIG. 19 is a graph showing a relationship between rubbing fuzz and sizing amount (Methylated melamine-formaldehyde, T700SC-12K);

FIG. 20 is a graph showing a relationship between ILSS 5 and sizing amount (Methylated melamine-formaldehyde, T700SC-12K);

FIG. 21 is a graph showing a TGA measurement result of T700S type fiber coated with methylated melamine-formaldehyde;

FIG. 22 is a graph showing a TGA measurement result of methylated melamine-formaldehyde;

FIG. 23 is a graph showing a relationship between strand tensile strength and sizing amount (Epoxy cresol novolac, T700SC-12K);

FIG. 24 is a graph showing a relationship between drape value and sizing amount (Epoxy cresol novolac, T700SC-12K);

FIG. 25 is a graph showing a relationship between rubbing fuzz and sizing amount (Epoxy cresol novolac, T700SC-12K);

FIG. 26 is a graph showing a relationship between ILSS and sizing amount (Epoxy cresol novolac, T700SC-12K);

FIG. 27 is a graph showing a TGA measurement result of T700S type fiber coated with epoxy cresol novolac;

FIG. 28 is a graph showing a TGA measurement result of epoxy cresol novolac;

FIG. 29 is a graph showing adhesion strength between a T800S type fiber and polyetherimide resin;

FIG. 30 is a graph showing adhesion strength between a T700S type fiber and polyetherimide resin;

FIG. 31 is a schematic view showing a measurement procedure of drape value;

FIG. 32 is a schematic view showing a measurement instrument of rubbing fuzz;

FIG. 33 is geometry of a dumbbell shaped specimen for Single Fiber Fragmentation Test;

Table 1 shows a relationship between strand tensile strength and sizing amount (KAPTON type polyimide, T800SC-24K);

Table 2 shows a relationship between drape value and sizing amount (KAPTON type polyimide, T800SC-24K);

Table 3 shows a relationship between rubbing fuzz and sizing amount (KAPTON type polyimide, T800SC-24K);

Table 4 shows a relationship between ILSS and sizing amount (KAPTON type polyimide, T800SC-24K);

Table 5 shows a relationship between strand tensile strength and sizing amount (ULTEM type polyetherimide, T800SC-24K);

Table 6 shows a relationship between drape value and sizing amount (ULTEM type polyetherimide, T800SC-24K);

Table 7 shows a relationship between rubbing fuzz and sizing amount (ULTEM type polyetherimide, T800SC-24K);

Table 8 shows a relationship between ILSS and sizing amount (ULTEM type polyetherimide, T800SC-24K);

Table 9 shows a relationship between strand tensile strength and sizing amount (ULTEM type polyetherimide, T700SC-12K);

Table 10 shows a relationship between drape value and sizing amount (ULTEM type polyetherimide, T700SC-12K);

Table 11 shows a relationship between rubbing fuzz and sizing amount (ULTEM type polyetherimide, T700SC-12K);

Table 12 shows a relationship between ILSS and sizing amount (ULTEM type polyetherimide, T700SC-12K);

Table 13 shows a relationship between strand tensile strength and sizing amount (Methylated melamine-formaldehyde, T700SC-12K);

Table 14 shows a relationship between drape value and sizing amount (Methylated melamine-formaldehyde, T700SC-12K);

Table 15 shows a relationship between rubbing fuzz and sizing amount (Methylated melamine-formaldehyde, T700SC-12K);

Table 16 shows a relationship between ILSS and sizing amount (Methylated melamine-formaldehyde, T700SC-12K);

Table 17 shows a relationship between strand tensile strength and sizing amount (Epoxy cresol novolac, T700SC-12K);

Table 18 shows a relationship between drape value and sizing amount (Epoxy cresol novolac, T700SC-12K);

Table 19 shows a relationship between rubbing fuzz and sizing amount (Epoxy cresol novolac, T700SC-12K);

Table 20 shows a relationship between ILSS and sizing amount (Epoxy cresol novolac, T700SC-12K);

Table 21 shows a comparison result of composite properties; Table 22 shows adhesion strength between a T800S type fiber and polyetherimide resin; and

Table 23 shows adhesion strength between a T700S type fiber and polyetherimide resin.

### DETAILED DESCRIPTION OF PREFERRED EMBODIMENTS

Embodiments of the present invention will be explained with reference to the accompanying drawings.

In the embodiment, a commercially available carbon fiber is used (including graphite fiber). Specifically, a pitch type carbon fiber, a rayon type carbon fiber, or a PAN (polyacrylonitrile) type carbon fiber is used. Among these carbon fibers, the PAN type carbon fibers that have high tensile strength are the most desirable for the invention.

Among the carbon fibers, there are a twisted carbon fiber, an untwisted carbon fiber and a never twisted carbon fiber. The carbon fibers have preferably a yield of 0.06 to 4.0 g/m and a filament number of 1,000 to 48,000. In order to have high tensile strength and high tensile modulus in addition to preventing single filament breakage from happening during the carbon fiber production, the single filament diameter should be within 3 pm to 8 pm, more ideally, 4 pm to 7 pm.

Strand strength is 3.0 GPa or above. 4.5 GPa or above is more desirable. 5.5 GPa or above is even more desirable. Tensile modulus is 200 GPa or above. 220 GPa or above is more desirable. 240 GPa or above is even more desirable. If the strand strength and modulus of the carbon fiber are below 3.0 GPa and 200 GPa, respectively, it is difficult to obtain the desirable mechanical property when the carbon fiber is made into composites materials.

The desirable sizing amount on carbon fiber is between 0.05 and 0.30 weight %. Between 0.05 and 0.25 weight % is more desirable. Between 0.05 and 0.20 weight % is even more desirable. If the sizing amount is less than 0.05 weight %, when carbon fiber tow is spread with some tension, fuzz becomes an issue. If on the other hand, the sizing amount is above 0.30 weight %, the carbon fiber is almost completely coated by the heat resistant polymer and would develop voids, resulting in poor density (low), and poor spreadability. When this occurs, even low viscosity resins such as epoxy resins have experienced reduced impregnation; thereby leading to low mechanical properties. In addition from an environmental standpoint, if the sizing amount is above 0.30 weight %, the possibility that harmful volatiles are generated becomes higher.

The desirable relation B/A is over 1.05, and more desirable relation B/A is over 1.1, where A is IFSS (Interfacial Shear Strength) of unsized fiber and B is IFSS of sized fiber in the present invention whose surface treatment must be same as the unsized fiber. IFSS can be measured with a SFFT (Single Fiber Fragmentation Test), and unsized fiber could be de-sized fiber. A SFFT procedure and a de-sizing method will be described later.

The continuous process including carbonization, sizing application, drying and winding is preferred. If the process is not continuous, the possibility of fuzz generation and contamination becomes higher.

In order to obtain composites with high mechanical properties, it is desirable to use continuous fiber when molding, and chopped and/or long fiber reinforced thermoplastic pellet may also be used. In terms of the types of carbon fibers, chopped fiber for mold injection, continuous fiber for filament winding or pultrusion, weaving, braiding, or a mat form could be also used.

In order for the carbon fiber to have superior spreadability and effective resin impregnation, a drape ability (measured by the procedures described below) can be defined as drape value having less than 15 cm, 12 cm or less is better, 10 cm or less is even more desirable, 8 cm or less is most desirable.

As to the matrix resin, either thermosetting or thermoplastic resins could be used. As for the thermosetting resins, the invention is not limited to any particular resins, and a thermosetting polyimide resin, an epoxy resin, a polyester resin, a polyurethane resin, a urea resin, a phenol resin, a melamine resin, a cyanate ester resin, and a bismaleimide resin may be used. As for the thermoplastic resin, resins, mostly heat resistant resins, that contain oligomer could be used. The invention is not limited to any particular heat resistant thermoplastic resins, and a thermoplastic polyimide resin, a polyamideimide resin, a polyetherimide resin, a polysulfone resin, a polyethersulfone resin, a polyetheretherketone resin, a polyetherketoneketone resin, and a polyphenylenesulfide resin may be used.

A heat resistant polymer is a desirable sizing agent to be used for coating the carbon fiber. The sizing agents include a phenol resin, a urea resin, a melamine resin, a polysulfone resin, a polyethersulfone resin, a polyetheretherketone resin, a polyetherketoneketone resin, a polyphenylenesulfide resin, a polyimide resin, a polyamideimide resin, a polyetherimide resin, and others. For some types of sizings, when the heat resistant polymer or polymer precursor is reacted chemically in order to obtain heat resistant polymer coating on a carbon fiber, water could be generated as a condensation product. For these sizings, it is desirable to complete the reaction in the process of the sizing application as much as possible. Otherwise, voids in a composite could become a problem due to water generation. An example of a heat resistant polymer will be shown as below.

A polyimide is made by heat reaction or chemical reaction of polyamic acid. During the imidization process, water is generated; therefore, it is important to complete imidization before composite fabrication. A water generation ratio W based on a carbon fiber during a composite fabrication process is preferably 0.05 weight % or less. 0.03 weight % or less is desirable. Ideally, 0.01 weight % or less is optimal. The water generation ratio W can be defined by the following equation:

W(weight %)=B/A×100

where a weight A of a sized fiber is measured after holding 2 hours at 110 degrees Celsius and a weight difference B of a sized fiber is measured between 130 degrees Celsius and 415 degrees Celsius under air atmosphere with TGA (holding 110 degrees Celsius for 2 hours, then heating up to 450 degrees Celsius at 10 degrees Celsius/min).

An imidization ratio X of 80% or higher is acceptable, and 90% or better is desirable. Ideally, 95% or higher is 5 optimal. The imidization ratio X is defined by the following equation:

X(%)=(1−D/C)×100

where a weight loss ratio C of a polyamic acid without being imidized and a weight loss ratio D of a polyimide are measured between 130 degrees Celsius and 415 degrees Celsius under air atmosphere with TGA (holding 110 degrees Celsius for 2 hours, then heating up to 450 degrees Celsius at 10 degrees Celsius/minute).

A degree of imidization is qualitatively measured using 15 an infrared absorption spectrum of the polyimide with FTIR (Fourier transform infrared spectroscopy) which enables one to measure the spectrum absorption level of an imide bond (C=0 stretching vibration) at approximately 1,780 cm⁻¹.

A weight loss ratio Ws based on the sizing amount can be defined by the following equation:

Ws(%)=E/F×100

where a weight F is the amount of the sizing and a weight difference E is measured between 130 degrees Celsius and 415 degrees Celsius under air atmosphere with TGA (holding 110 degrees Celsius for 2 hours, then heating up to 450 degrees Celsius at 10 degrees Celsius/min).

The weight loss ratio based on the sizing amount of 7% or less is acceptable, and 5% or less is desirable. Ideally, 3% or less is optimal.

The heat resistant polymer is preferably used in a form of an organic solvent solution, a water solution, a water dispersion or a water emulsion of the polymer itself or a polymer precursor. A polyamic acid which is the precursor to a polyimide is enabled to be water soluble by neutralization with alkali. It is better for alkali to be water soluble. Chemicals such as ammonia, a monoalkyl amine, a dialkyl amine, a trialkyl amine, and tetraalkylammonium hydroxide could be used.

Organic solvents such as DMF (dimethylformamide), DMAc (dimethylacetamide), DMSO (dimethylsulfoxide), NMP (N-methylpyrrolidone), THE (tetrahydrofuran), etc. could be used. Naturally, low boiling point and safe solvents should be selected. It is desirable that the sizing agent is dried and sometimes reacted chemically in low oxygen concentration air or inert atmosphere such as nitrogen to avoid forming explosive mixed gas.

### <Glass Transition Temperature>

The sizing has a glass transition temperature above 100 degrees Celsius. Above 150 degrees Celsius is better. Even more preferably the glass transition temperature shall be above 200 degrees Celsius.

A glass transition temperature is measured according to 20 ASTM E1640 Standard Test Method for “Assignment of the Glass Transition Temperature by Dynamic Mechanical Analysis” using a Differential Scanning calorimetry (DSC).

### <Thermal Degradation Onset Temperature>

A thermal degradation onset temperature of a sized fiber is preferably above 300 degrees Celsius. 370 degrees Celsius or higher is more desirable, 450 degrees Celsius or higher is most desirable. When a thermal degradation onset temperature is measured, first, a sample with a weight of about 5 mg is dried in an oven at 110 degrees Celsius for 2 hours, and cooled down to room temperature. Then it is weighed and placed on a thermogravimetric analyzer (TGA) under air atmosphere. Then, the sample is analyzed under an air flow of 60 ml/minute at a heating ratio of 10 degrees Celsius/minute. A weight change is measured between room temperature and 650 degrees Celsius. The degradation onset temperature of a sized fiber is defined as a temperature at which an onset of a major weight loss occurs. From the TGA experimental data, the sample weight, expressed as a percentage of the initial weight, is plotted as a function of the temperature (abscissa). By drawing tangents on a curve, the thermal degradation onset temperature is defined as an intersection point where tangent at a steepest weight loss crosses a tangent at minimum gradient weight loss adjacent to the steepest weight loss on a lower temperature side.

The definition of a thermal degradation onset temperature applies to the state of a carbon fiber after the chemical reaction but before a resin impregnation. The heat resistant property is imparted to the sized fiber by a chemical reaction affected before resin is impregnated.

If it is difficult to measure a thermal degradation onset temperature of a sized fiber, a sizing can be used in 20 place of a sized fiber.

### <30% Weight Reduction Temperature>

A 30% weight reduction temperature of a sizing is preferably higher than 350 degrees Celsius. 420 degrees Celsius or higher is more desirable. 500 degrees Celsius or higher is most desirable. When a 30% weight reduction temperature is measured, first, a sample with a weight of about 5 mg is dried in an oven at 110 degrees Celsius for 2 hours, and cooled down to room temperature. Then it is weighed and placed on a thermogravimetric analyzer (TGA) under air atmosphere. Then, the sample is analyzed under an air flow of 60 ml/minute at a heating ratio of 10 degrees Celsius/minute. A weight change is measured between room temperature and 650 degrees Celsius. From the TGA experimental data, the sample weight, expressed as a percentage of the initial weight, is plotted as a function of the temperature (abscissa). The 30% weight reduction temperature of the sizing is defined as a temperature at which the weight of the sizing reduces by 30% with reference to the weight of the said sizing at 130 degrees Celsius.

### <Sizing Agent Application Method>

A sizing agent application method include a roller sizing method, a submerged roller sizing method and/or a spray sizing method. The submerged roller sizing method is desirable because it is possible to apply a sizing agent very evenly even to large filament count tow fibers. Sufficiently spread carbon fibers are submerged in the sizing agent. important such fiber tension, optimal sizing amount for the ultimate realized. Often, ultrasonic agitation carbon fiber during the sizing process results.

In order to weight % on the carbon fiber, the bath sizing concentration is preferably 0.05 to 2.0 weight %, more preferably 0.1 to 1.0 weight %.

### <Drying Treatment>

After the sizing application process, the carbon fiber goes through the drying treatment process in which water and/or organic solvent will be dried, which are solvent or dispersion media. Normally an air dryer is used and the dryer is run for 6 seconds to 15 minutes. The dry temperature should be set at 200 degrees Celsius to 450 degrees Celsius, 240 degrees Celsius to 410 degrees Celsius would be more ideal, 260 degrees Celsius to 370 degrees Celsius would be even more ideal, and 280 degrees Celsius to 330 degrees Celsius would be most desirable.

In case of thermoplastic dispersion, it is desirable that it should be dried at over the formed or softened temperature. This could also serve a purpose of reacting to the desired polymer characteristics. For this invention, the heat treatment will possibly be used with a higher 10 temperature than the temperature used for the drying treatment. The atmosphere to be used for the drying treatment should be air; however, when an organic solvent is used in the process, an inert atmosphere involving elements such as nitrogen could be used.

### <Winding Process>

The carbon fiber tow, then, is wound onto a bobbin. The carbon fiber produced as described above is evenly sized. This helps make desired carbon fiber reinforced composites materials when mixed with the resin.

### Examples

Examples of the carbon fiber will be explained next. The following methods are used for evaluating properties of 25 the carbon fiber.

### <Sizing Amount>

Sizing amount in this invention is defined as the higher of the values obtained by the following two methods outlined below, and is considered to represent a reasonably true estimate of the actual amount of sizing on the fiber.

### (Alkaline Method)

Sizing amount (weight %) is measured by the following method.

(1) About 5 g carbon fiber is taken.
(2) The sample is placed in an oven at 110 degrees Celsius for 1 hour.
(3) It is then placed in a desiccator to be cooled down to 5 the ambient temperature (room temperature).
(4) A weight Wo is weighed.
(5) For removing the sizing by alkaline degradation, it is put in 5% KOH solution at 80 degrees Celsius for 4 hours.
(6) The de-sized sample is rinsed with enough water and 10 placed in an oven for 1 hour at 110 degrees Celsius.
(7) It is placed in a desiccator to be cooled down to ambient temperature (room temperature).
(8) A weight W₁ is weighed.

The sizing amount (weight %) is calculated by the 15 following formula.

Sizing amount(weight %)=(W₀−W₁)/(W₀)×100

### (Burn Off Method)

The sizing amount (weight %) is measured by the following method.

(1) About 2 g carbon fiber is taken.
(2) The sample is placed in an oven at 110 degrees Celsius for 1 hour.
(3) It is then placed in a desiccator to be cooled down to ambient temperature (room temperature).
(4) A weight W₀ is weighed.
(5) For removing the sizing, it is placed in a furnace of nitrogen atmosphere at 450 degrees Celsius for 20 minutes, where the oxygen concentration is less than 7 weight %.
(6) The de-sized sample is placed in a nitrogen purged container for 1 hour.
(7) A weight W₁ is weighed.
The sizing amount (weight %) is calculated by the following formula.

Sizing amount(weight %)=(W₀−W₁)/(W₀)×100

### <Strand Mechanical Properties>

Tensile strength and tensile modulus of the strand specimen made of polymer coated carbon fiber and epoxy resin matrix is measured according to ASTM D4018 Standard Test Method for “Properties of Continuous Filament Carbon and Graphite Fiber Tows”.

### <Drape Value>

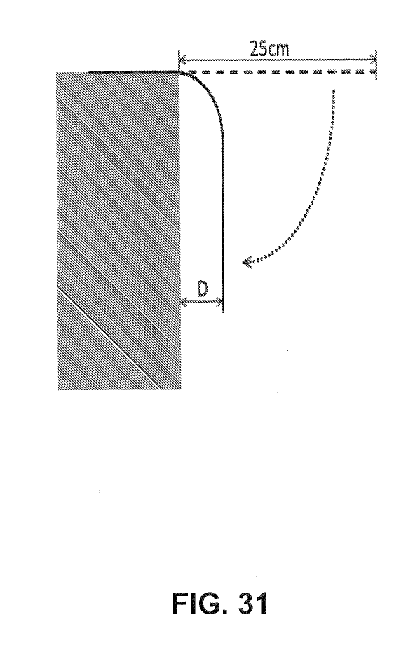

A carbon fiber tow is cut from the bobbin to a length of about 50 cm without applying any tension. A weight is attached on one end of the specimen after removing any twists and/or bends. The weight is 30 g for 12,000 filaments and 60 g for 24,000 filaments, so that 1 g tension is applied per 400 filaments. The specimen is then hung in a vertical position for 30 minutes with the weighted end hanging freely. After the weight is released from the specimen, the specimen is placed on a rectangular table such that a portion of the specimen is extended by 25 cm from an edge of the table having 90 degrees angle as shown in FIG. 31. The specimen on the table is fixed with an adhesive tape without breaking so that the portion hangs down from the edge of the table. A distance D (refer to FIG. 31) between a tip of the specimen and a side of the table is defined as the drape value.

### <Rubbing Fuzz Count>

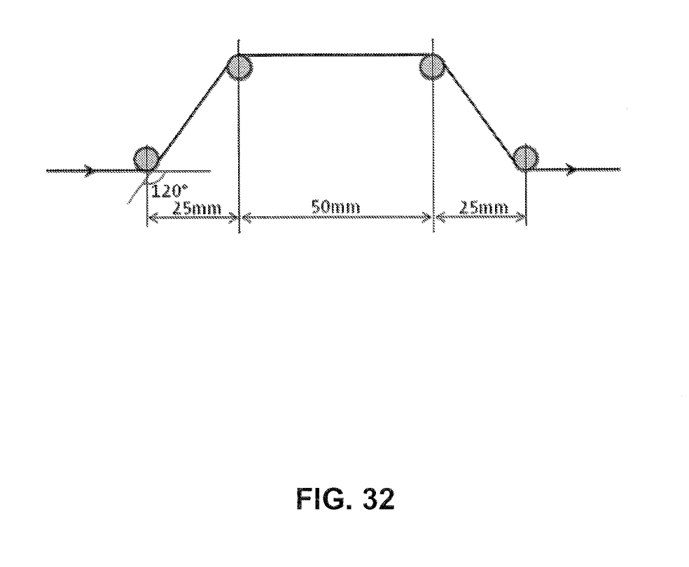

As shown in FIG. 32, a carbon fiber tow is slid against four pins with a diameter of 10 mm (material: chromium steel, surface roughness: 1 to 1.5 pm RMS) at a speed of 3 meter/minute in order to generate fuzz. The initial tension to a carbon fiber is 500 g for the 12,000 filament strand and 650 g for 24,000 filament strand. The carbon fiber is slid against the pins by an angle of 120 degrees. The four pins are placed (horizontal distance) 25 mm, 50 mm and 25 mm apart (refer to FIG. 32). After the carbon fiber passes through the pins, fuzz blocks light incident on a photo electric tube from above, so that a fuzz counter counts the fuzz count.

### <Interlaminar Shear Strength (ILSS)>

ILSS of the composites consisting of the polymer coated carbon fiber and an epoxy resin matrix is measured according to ASTM D2344 Standard Test Method for “Short-Beam Strength 15 of Polymer Matrix Composite Materials and Their Laminates”.

### <Single Fiber Fragmentation Test (SFFT)>

Specimens are prepared with the following procedure.

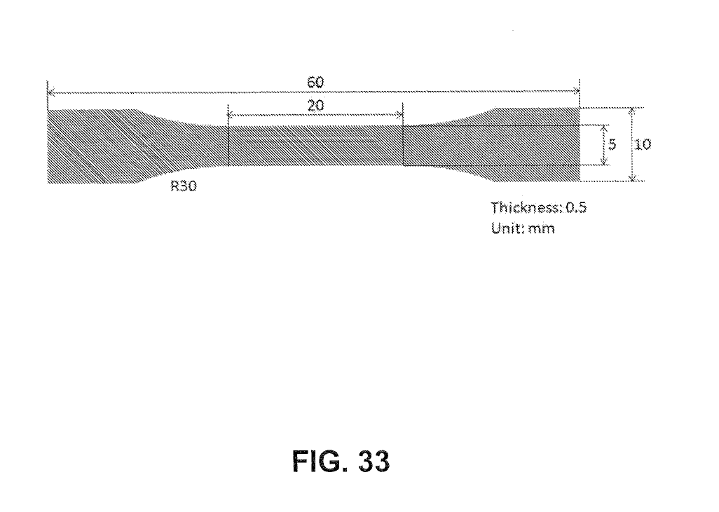

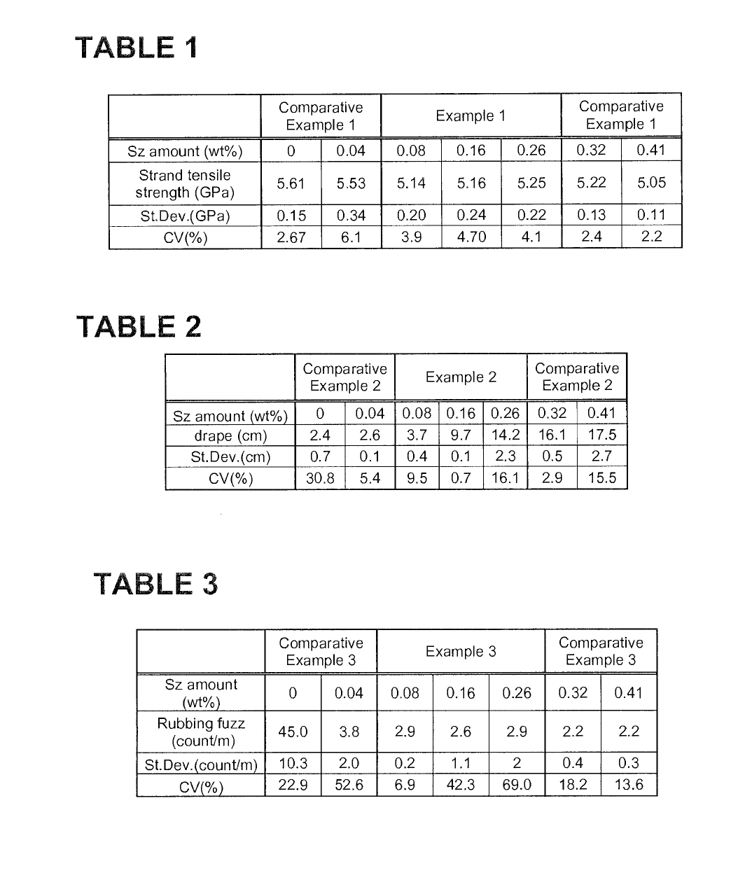

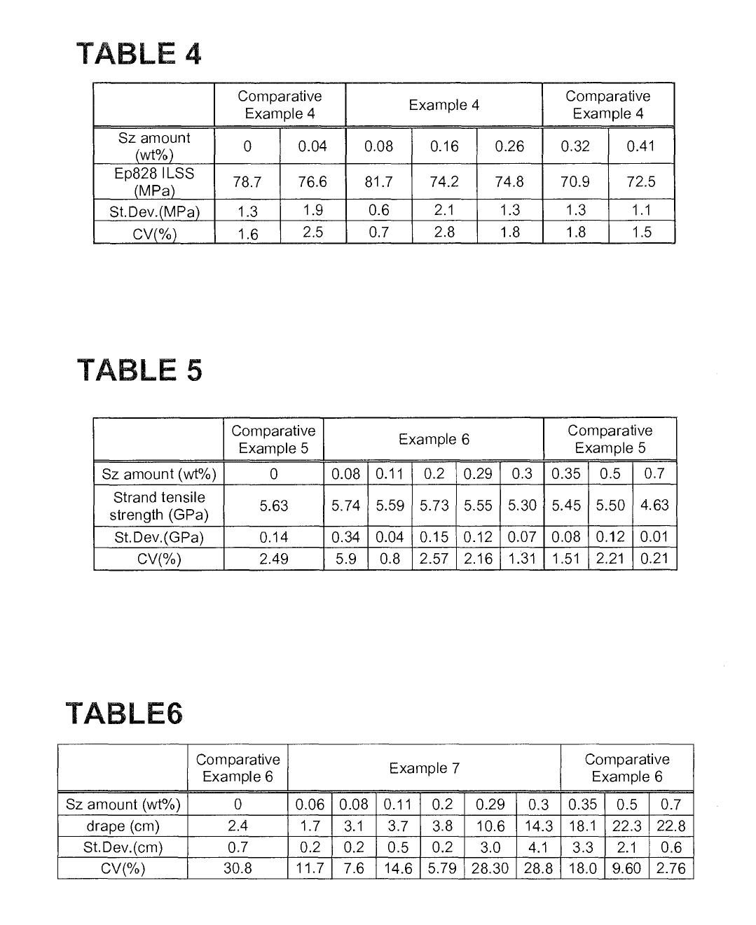

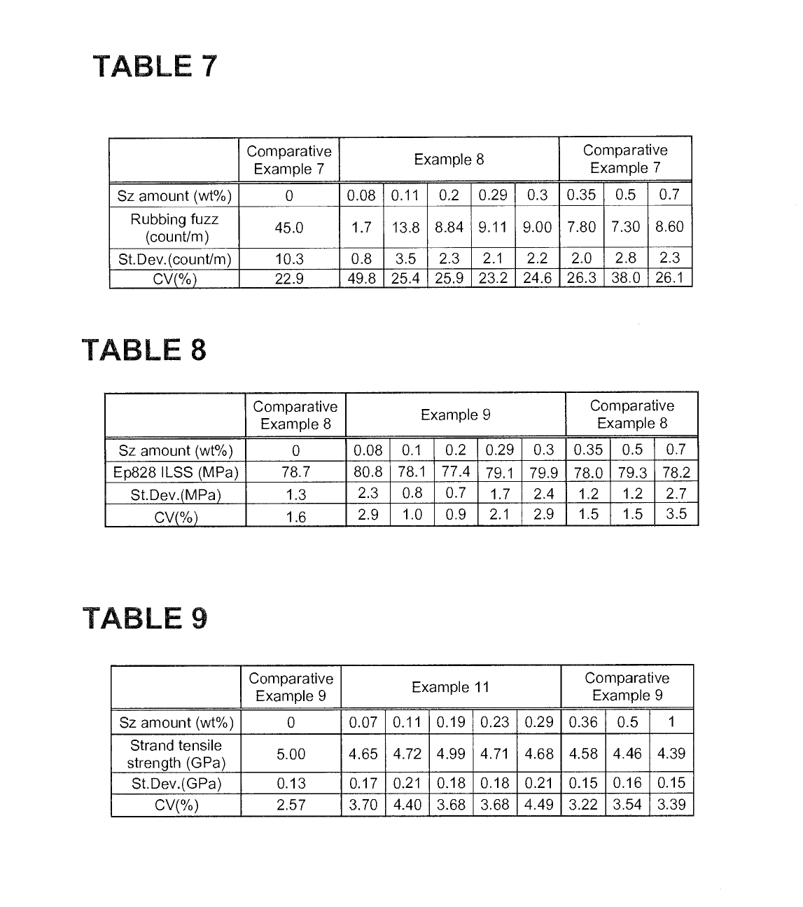

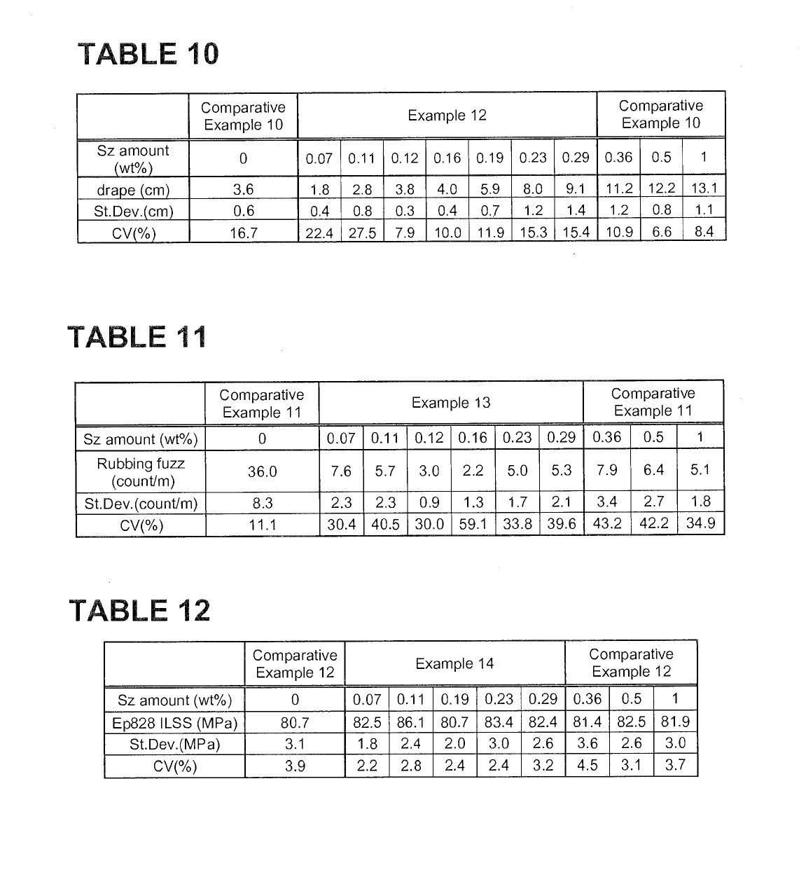

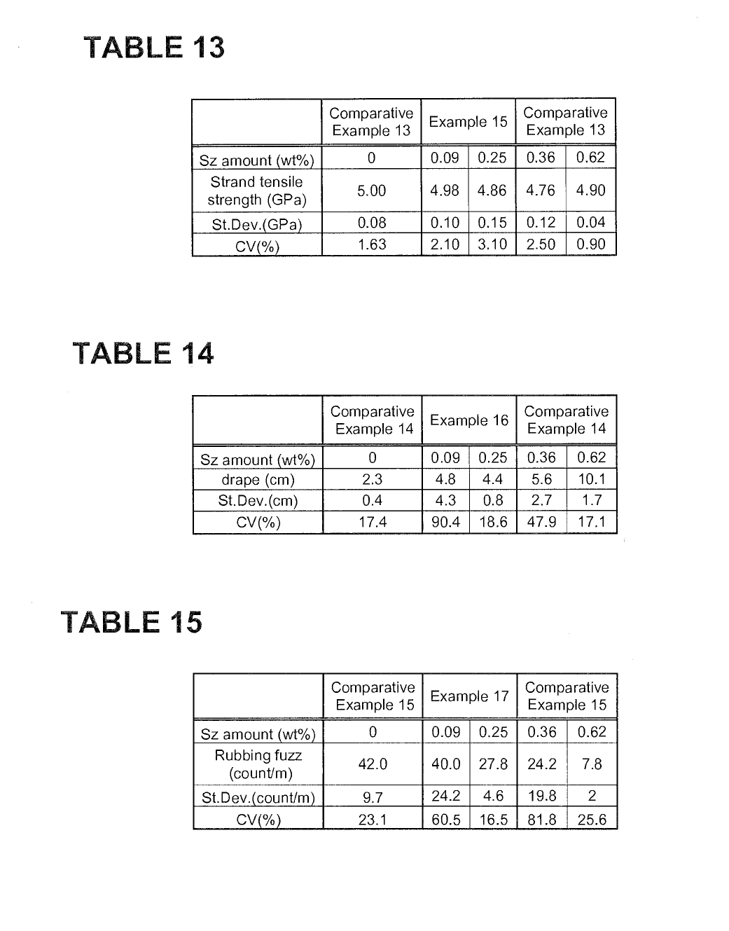

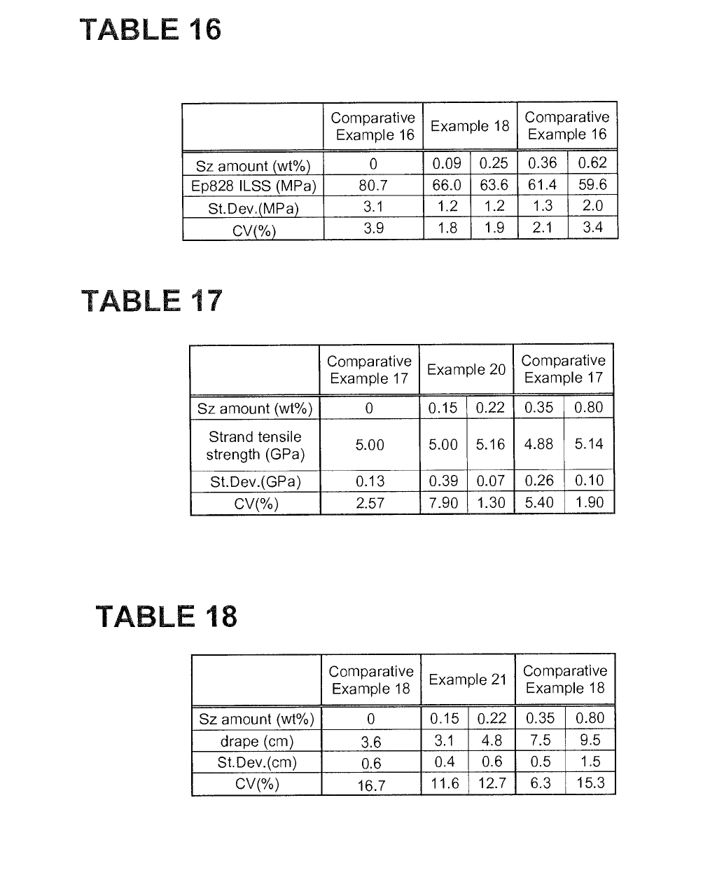

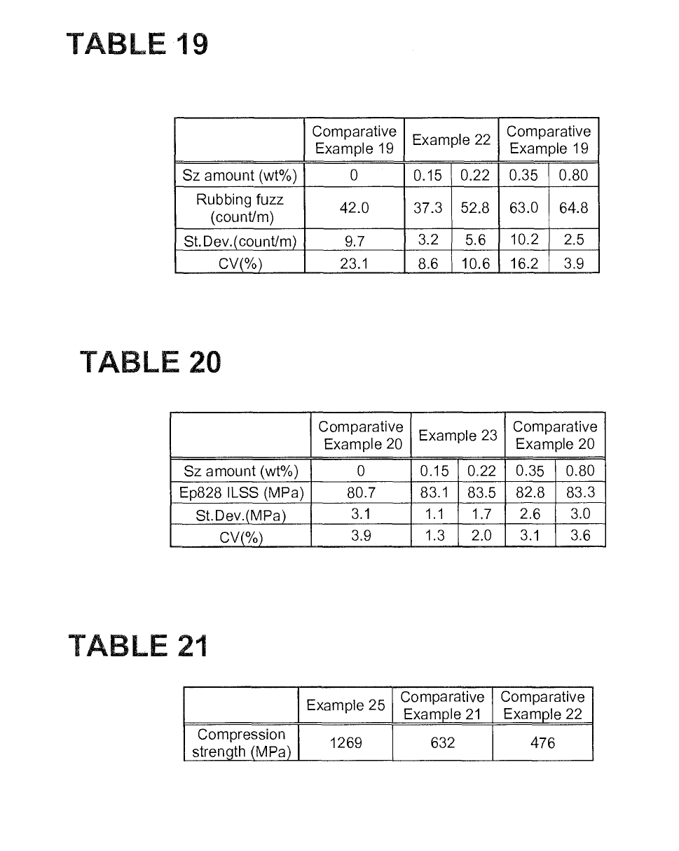

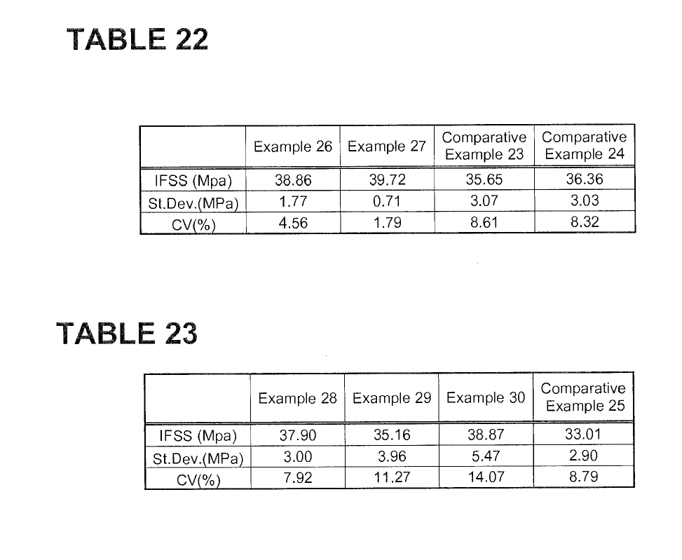

(1) Two aluminum plates (length: 250×width: 250×thickness: 6 (mm)), a KAPTON film (thickness: 0.1 (mm)), a KAPTON tape, a mold release agent, an ULTEM type polyetherimide resin sheet (thickness 0.26 (mm)), which must be dried in a vacuum oven at 110 degrees Celsius for at least 1 day, and carbon fiber strand are prepared.
(2) The KAPTON film (thickness: 0.1 (mm)) coated with a mold release agent is set on an aluminum plate.
(3) The ULTEM type polyetherimide resin sheet (length: 90×width: 150×thickness: 0.26 (mm)), whose grease on the surface is removed with acetone, is set on the KAPTON film.
(4) A single filament is picked up from the carbon fiber strand and set on the ULTEM type polyetherimide resin sheet.
(5) The filament is fixed at the both sides with a KAPTON tape to be kept straight.
(6) The filament (filaments) is overlapped with another ULTEM type polyetherimide resin sheet (length: 90×width: 150×thickness: 0.26 (mm)), and KAPTON film (thickness: 0.1 (mm)) coated with a mold release agent is overlapped on it.
(7) Spacers (thickness: 0.7 (mm)) are set between two aluminum plates.
(8) The aluminum plates including a sample are set on the pressing machine at 290 degrees Celsius.
(9) They are heated for 10 minutes contacting with the 10 pressing machine at 0.1 MPa.
(10) They are pressed at 1 MPa and cooled at a speed of 15 degrees Celsius/minute being pressed at 1 MPa.
(11) They are taken out of the pressing machine when the temperature is below 180 degrees Celsius.
(12) A dumbbell shaped specimen, where a single filament is embedded in the center along the loading direction, has the center length 20 mm, the center width 5 mm and the thickness 0.5 mm as shown in FIG. 33.

SFFT is performed at an instantaneous strain rate of approximately 4%/minute counting the fragmented fiber number in the center 20 mm of the specimen at every 0.64% strain with a polarized microscope until the saturation of fragmented fiber number. The preferable number of specimens is more than 2 and Interfacial Shear Strength (IFSS) is obtained from the average length of the fragmented fibers at the saturation point of fragmented fiber number. IFSS can be calculated from the equation below, where σ_{f} is the strand strength, d is the fiber diameter, L_{c}, is the critical length (=4*L_{b}/3) and L_{b} is the average length of 30 fragmented fibers.

$$IFSS = \frac{σ f \cdot d}{2 Lc}$$

### <De-Sizing Process>

De-sized fiber may be used for SFFT in place of unsized fiber. De-sizing process is as follows.

(1) Sized fiber is placed in a furnace of nitrogen 5 atmosphere at 500 degrees Celsius, where the oxygen concentration is less than 7 weight %.
(2) The fiber is kept in the furnace for 20 minutes.
(3) The de-sized fiber is cooled down to room temperature in nitrogen atmosphere for 1 hour.

### EXAMPLES

### Example 1, Comparative Example 1

Unsized 24K high tensile strength, intermediate modulus carbon fiber “Torayca” T800SC (Registered trademark by Toray Industries; strand strength 5.9 GPa, strand modulus 294 GPa) was used. The carbon fiber was continuously submerged in the sizing bath containing polyamic acid ammonium salt of 0.1 to 1.0 weight°. The polyamic acid is formed from the monomers pyromellitic dianyhydride and 4,4′-oxydiphenylene. After the submerging process, it was dried at 300 degrees Celsius for 1 minute in order to have poly(4,4′-oxydiphenylene-pyromellitimide) (KAPTON type polyimide) coating. The sizing amount was measured with an alkaline method.

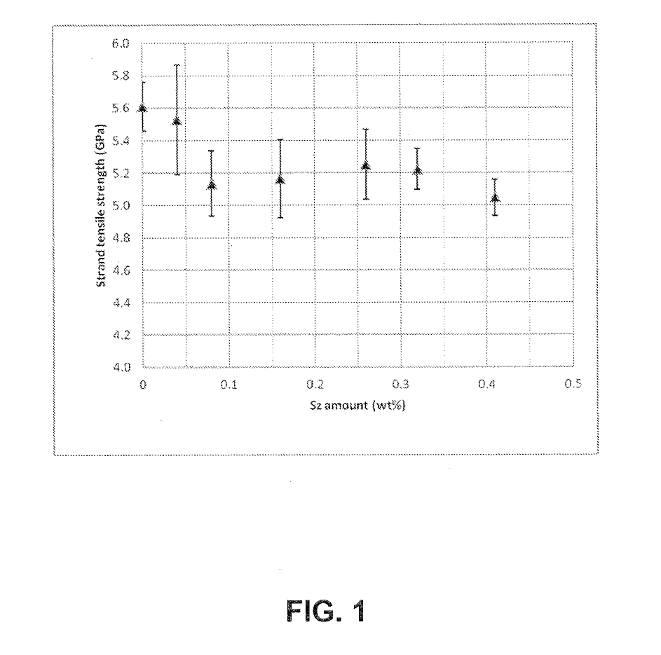

The tensile strengths of both the sizing amount of 0.05 to 0.30 weight % (Example 1) and 0.31 to 0.41 weight % (Comparative Example 1) were measured. The results are shown in both Table 1 and FIG. 1. The error bar in the figure indicates the standard deviation. Additionally, the mechanical properties of unsized fiber and 0.04 weight % are also shown.

### Example 2, Comparative Example 2

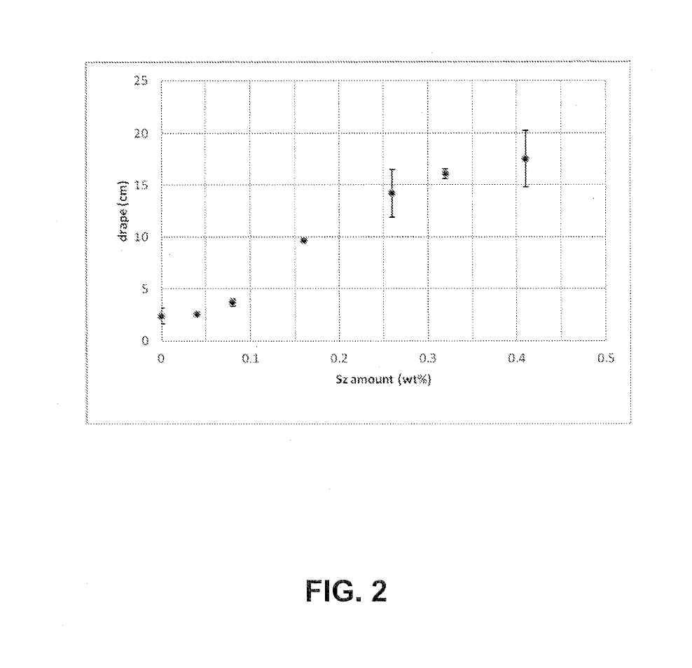

The same as the above Example 1 and Comparative Example 1, the samples were made, i.e. one with sizing amount of 0.05 to 0.30 weight % (Example 2) and the other with 0.31 to 0.41 weight % (Comparative Example 2) to test the drape value. The result is indicated in both Table 2 and FIG. 2. The error bar in the figure indicates the standard deviation. As the sample of Example 2 has superior drapeability than that of Comparative Example 2, the sample of Example 2 demonstrates the superior spreadability and impregnation. Additionally, the drape values of unsized fiber and 0.04 weight % are also shown.

### Example 3, Comparative Example 3

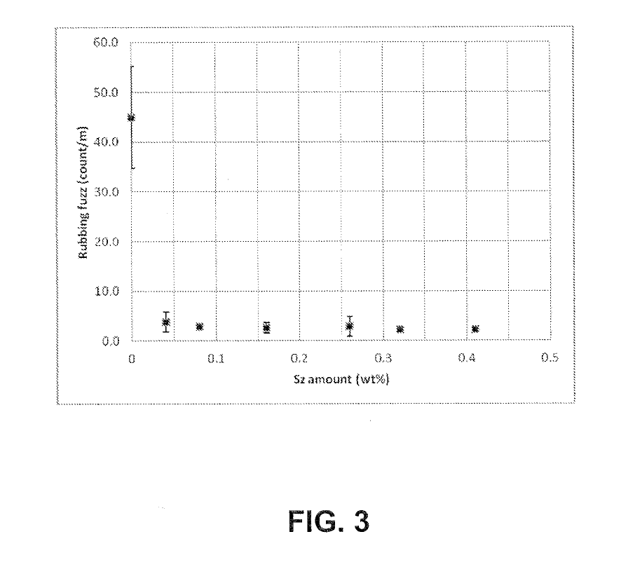

The same as the above Example 1 and Comparative Example 1, the samples were made, i.e. one with sizing amount of 0.05 to 0.30 weight % (Example 3), the other with 0.31 to 0.41 weight % (Comparative Example 3) and unsized fiber (Comparative Example 3) to conduct a fuzz count test. The result is shown in Table 3 and FIG. 3. The error bar in the figure indicates the standard deviation. The fuzz count of unsized fiber is extremely high and the fiber with 0.05 to 0.30 weight % amount sizing showed almost equal fuzz count as the fiber with 0.31 to 0.50 weight % amount sizing, indicating that the low sizing amount (0.05 to 0.30 weight %) carbon fiber could be processed as easily.

### Example 4, Comparative Example 4

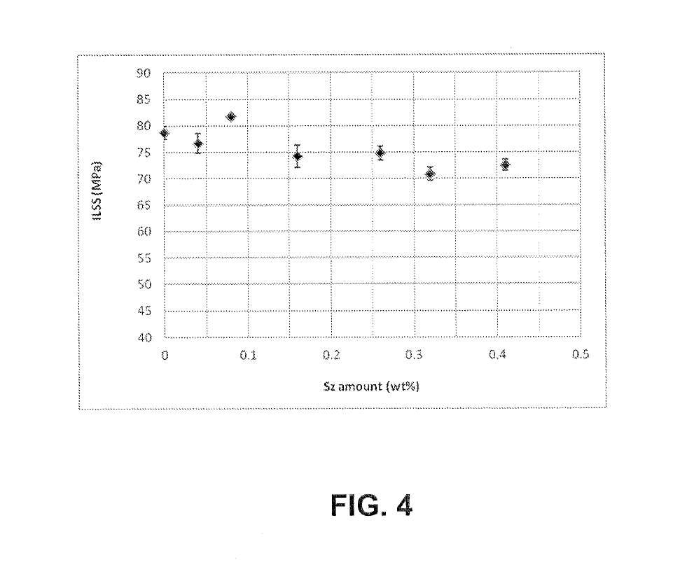

The same as the above Example 1 and Comparative Example 1, the samples were made, i.e. one with sizing amount of 0.05 to 0.30 weight % (Example 4) and the other with 0.31 to 0.41 weight % (Comparative Example 4) to conduct an ILSS test. The result is indicated in both Table 4 and FIG. 4. The error bar in the figure indicates the standard deviation. The ILSS measurements of the both samples taken from the test are almost identical, verifying that the low sized (0.05 to 0.30 weight %) carbon fiber also has superb interfacial adhesion. Additionally, the ILSS of unsized fiber and 0.04 weight % also shown.

### Example 5

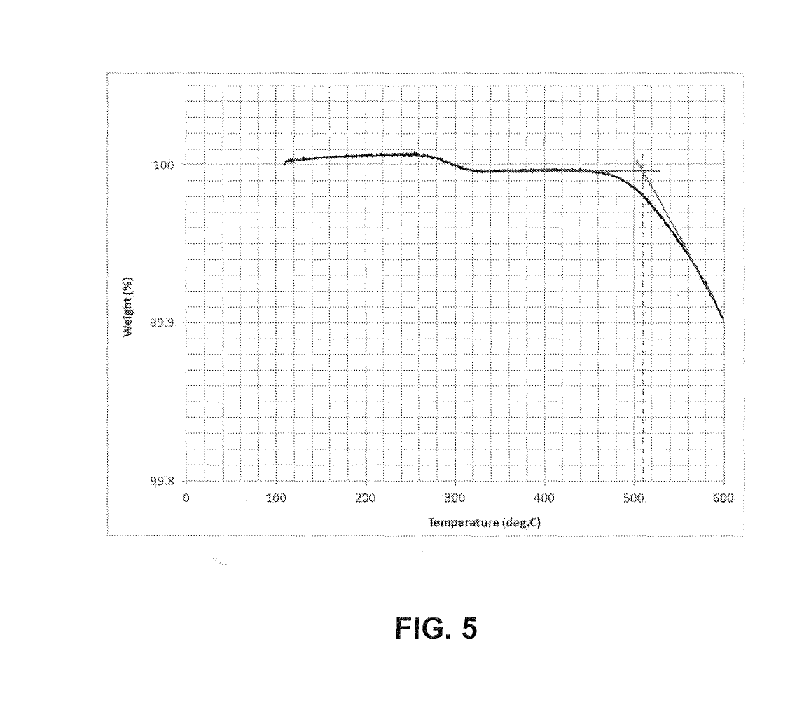

Thermogravimetric analysis (TGA) was conducted under air atmosphere. The heat degradation onset temperature of the same carbon fiber as the above Example 1 is 510 degrees Celsius as shown in FIG. 5. The heat degradation onset temperature of the sizing of the sizing is 585 degrees

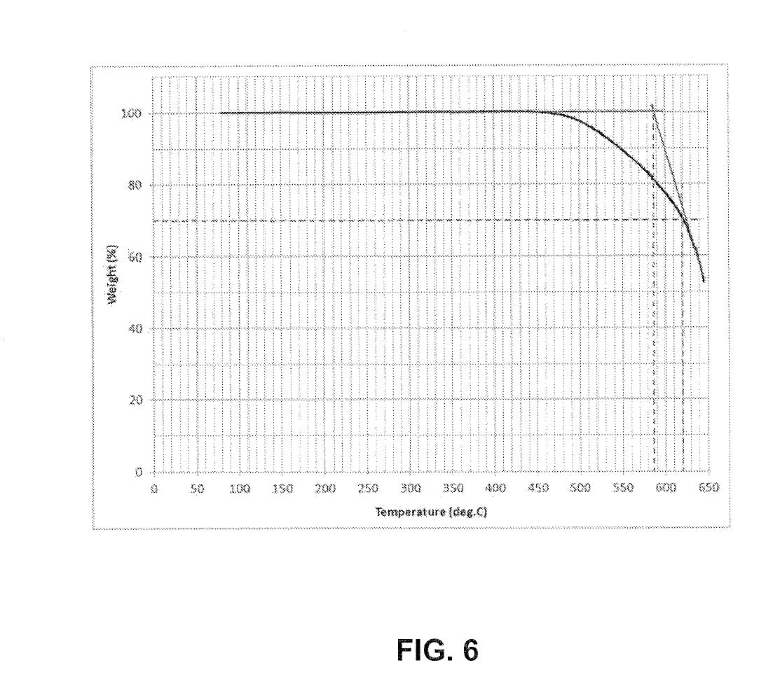

10 Celsius and the 30% weight reduction temperature is 620 degrees Celsius as shown in FIG. 6, confirming the heat resistance is in excess of 500 degrees Celsius.

### Example 6, Comparative Example 5

Unsized 24K high tensile strength, intermediate modulus carbon fiber “Torayca” T800SC (Registered trademark by Toray Industries; strand strength 5.9 GPa, strand modulus 294 GPa) was used. The carbon fiber was continuously submerged in the sizing bath containing polyamic acid dimethylaminoethanol salt of 0.1 to 2.0 weight %. The polyamic acid is formed from the monomers 2,2′-Bis(4-(3,4-dicarboxyphenol)phenyl) propane dianhydride and meta-phenylene diamine. After the submerging process, it was dried at 300 degrees Celsius for 1 minute in order to have 2,2-Bis(4-(3,4-dicarboxyphenol)phenyl)propane dianhydride-m-phenylene diamine copolymer (ULTEM type polyetherimide) coating. The imidization ratio was 98%. The sizing amount was measured with an alkaline method.

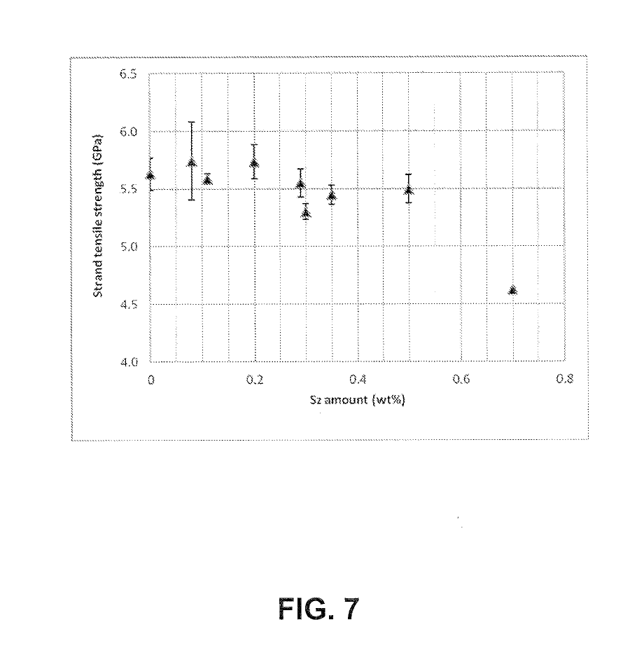

The tensile strengths of both the sizing amount of 0.05 to 0.30 weight % (Example 6) and 0.31 to 0.70 weight % (Comparative Example 5) were measured. The results are shown in both Table 5 and FIG. 7. The error bar in the figure indicates the standard deviation. The test sample of Example 6 had a higher tensile strength than that of Comparative Example 5. Additionally, the mechanical properties of unsized fiber are also shown.

### Example 7, Comparative Example 6

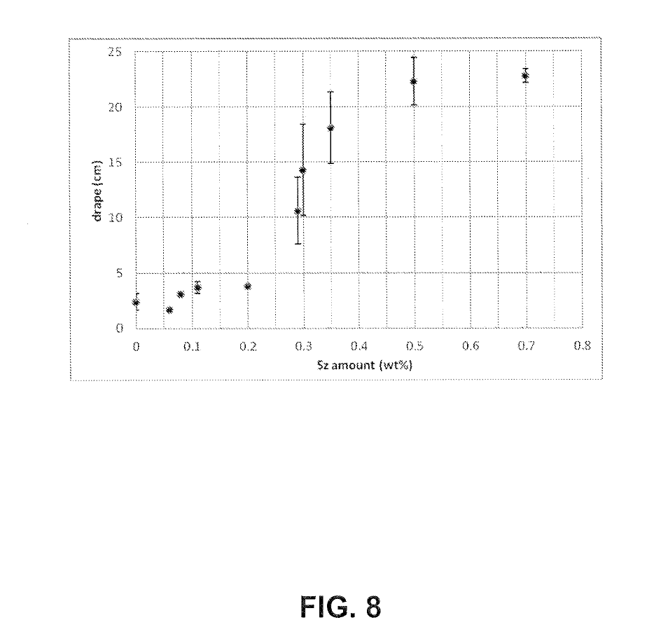

The same as the above Example 6 and Comparative Example 5, the samples were made, i.e. one with sizing amount of 0.05 to 0.30 weight % (Example 7) and the other with 0.31 to 0.70 weight % (Comparative Example 6) to test the drape value. The result is indicated in both Table 6 and FIG. 8. The error bar in the figure indicates the standard deviation. The sample of Example 7 has superior drapeability than that of Comparative Example 6. Additionally, the drape value of unsized fiber is also shown.

### Example 8, Comparative Example 7

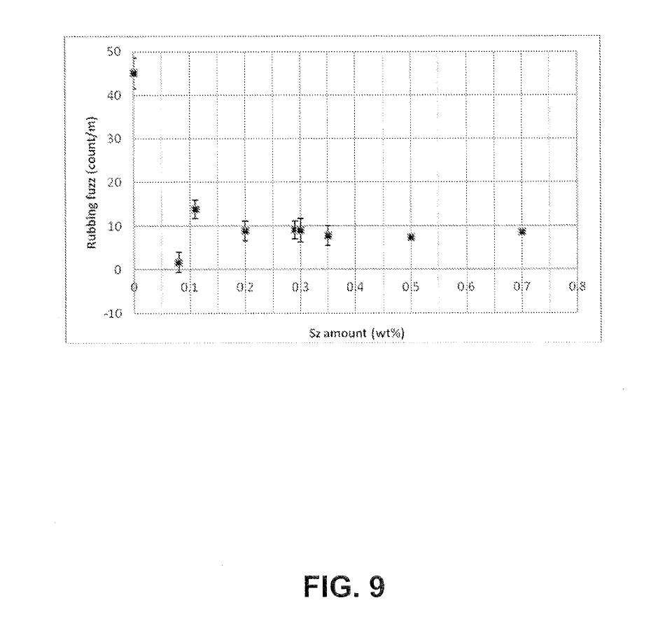

The same as the above Example 6 and Comparative Example 5, the samples were made, i.e. one with sizing amount of 0.05 to 0.30 weight % (Example 8) and the other with 0.31 to 0.70 weight % (Comparative Example 7) to conduct a fuzz count test. The result is shown in Table 7 and FIG. 9. The error bar in the figure indicates the standard deviation. The fuzz count of the both samples is almost equal. The unsized carbon fiber generated much fuzz, indicating the effectiveness of sizing in preventing fuzz occurrence.

### Example 9, Comparative Example 8

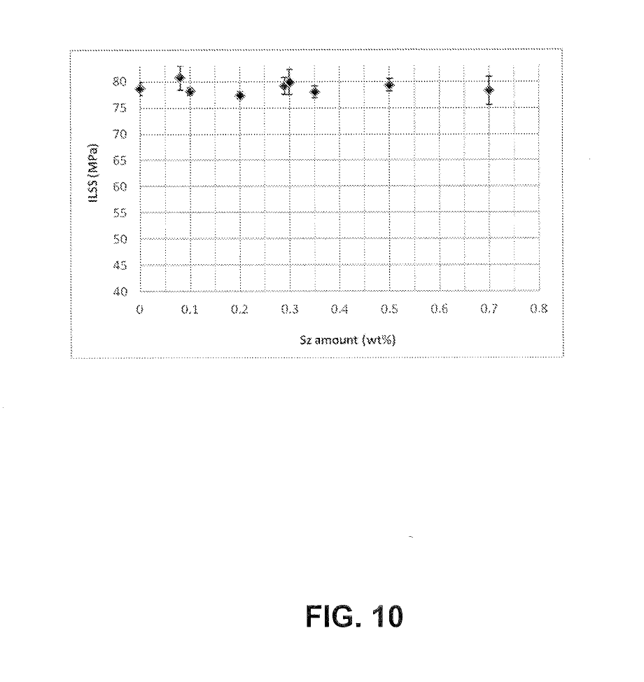

The same as the above Example 6 and Comparative Example 5, the samples were made, i.e. one with sizing amount of 0.05 to 0.30 weight % (Example 9) and the other with 0.31 to 0.70 weight % (Comparative Example 8) to conduct an ILSS test. The result is indicated in both Table 8 and FIG. 10. The error bar in the figure indicates the standard deviation. The ILSS measurements of the both samples taken from the test are almost identical, verifying that the low sized (0.05 to 0.30 weight %) carbon fiber also has superb interfacial adhesion. Additionally, the ILSS of unsized fiber is also shown.

### Example 10

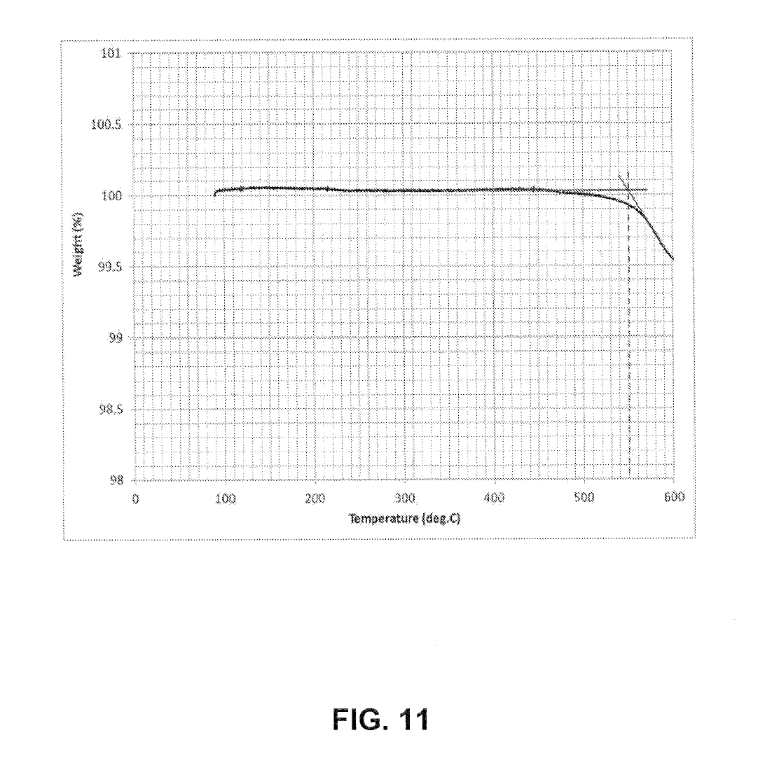

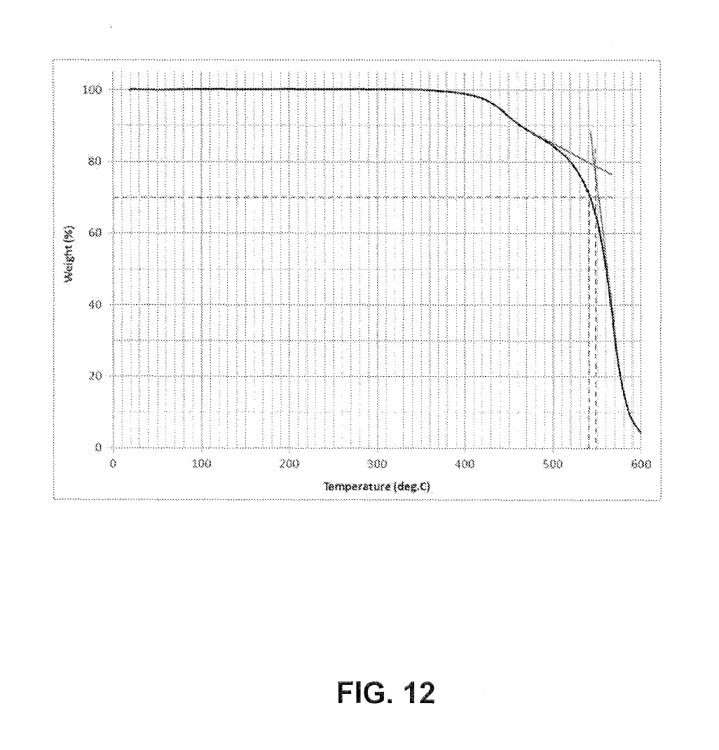

Thermogravimetric analysis (TGA) was conducted under air atmosphere. The heat degradation onset temperature of the same carbon fiber as the above Example 6 is over 550 degrees Celsius as shown in FIG. 11. The heat degradation onset temperature of the sizing was 548 degrees Celsius and the 30% weight reduction temperature is 540 degrees Celsius as shown in FIG. 12, confirming the heat resistance is in excess of 500 degrees Celsius.

### Example 11, Comparative Example 9

Unsized 12K high tensile strength, standard modulus carbon fiber “Torayca” T700SC (Registered trademark by Toray Industries—strand strength 4.9 GPa, strand modulus 230 GPa) was used. The carbon fiber was continuously submerged in the sizing bath containing polyamic acid dimethylaminoethanol salt of 0.1 to 2.0 weight %. The polyamic acid is formed from the monomers 2,2′-Bis(4-(3,4-dicarboxyphenol)phenyl) propane dianhydride and meta-phenylene diamine. After the submerging process, it was dried at 300 degrees Celsius for 1 minute in order to have ULTEM type polyetherimide coating. The imidization ratio was 98%. The sizing amount was measured with an alkaline method.

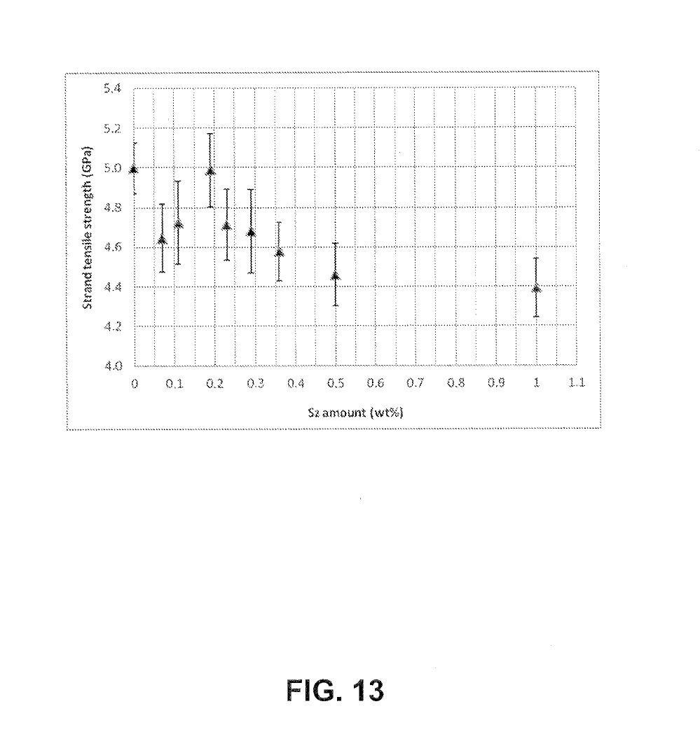

The tensile strengths of both the sizing amount of 0.05 to 0.30 weight % (Example 11) and 0.31 to 1.00 weight % (Comparative Example 9) were measured. The results are shown in both Table 9 and FIG. 13. The error bar in the figure indicates the standard deviation. The test sample of Example 11 had a higher tensile strength than that of Comparative Example 9. Additionally, the mechanical properties of unsized fiber are also shown.

### Example 12, Comparative Example 10

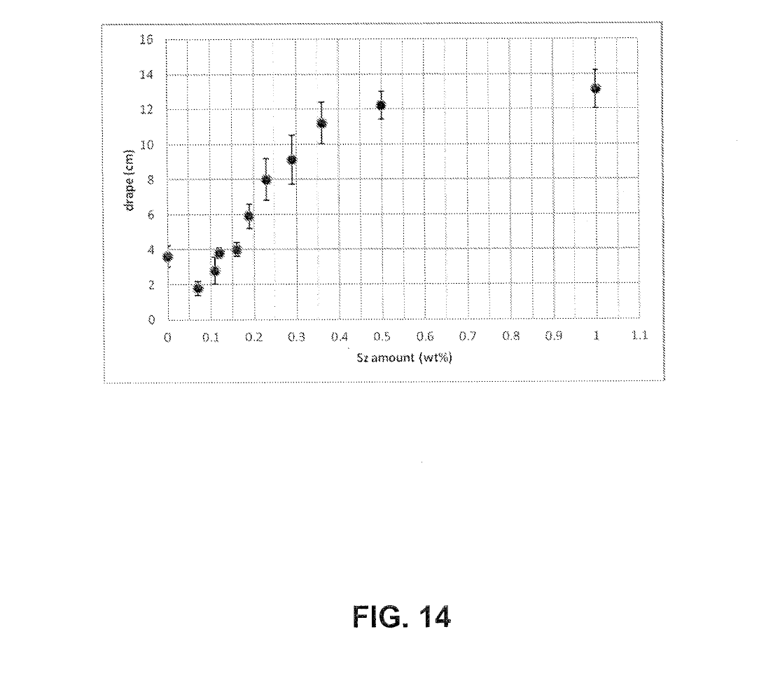

The same as the above Example 11 and Comparative Example 9, the samples were made, i.e. one with sizing amount of 0.05 to 0.30 weight % (Example 12) and the other with 0.31 to 1.00 weight % (Comparative Example 10) to test the drape value. The result is indicated in both Table 10 and FIG. 14. The error bar in the figure indicates the standard deviation. The sample of Example 12 has superior drapeability than that of Comparative Example 10. Additionally, the drape value of unsized fiber is also shown.

### Example 13, Comparative Example 11

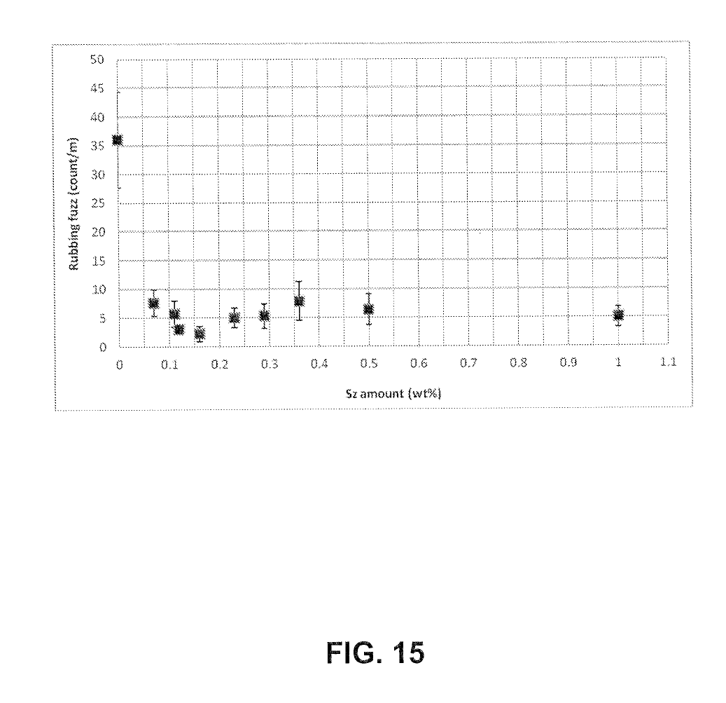

The same as the above Example 11 and Comparative Example 9, the samples were made, i.e. one with sizing amount of 0.05 to 0.30 weight % (Example 13), the other with 0.31 to 1.00 weight % (Comparative Example 11) and unsized fiber (Comparative Example 11) to conduct a fuzz count test. The result is shown in Table 11 and FIG. 15. The error bar in the figure indicates the standard deviation. The fuzz count of the both samples is almost equal. The carbon fiber without a sizing agent generated much fuzz indicating the effectiveness of sizing in preventing fuzz occurrence.

### Example 14, Comparative Example 12

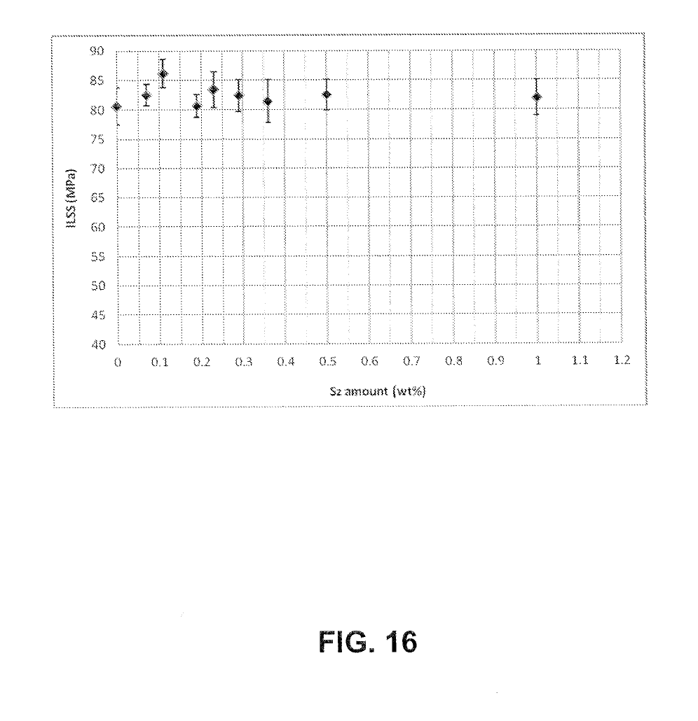

The same as the above Example 11 and Comparative Example 9, the samples were made, i.e. one with sizing amount of 0.05 to 0.30 weight % (Example 14) and the other with 0.31 to 1.00 weight % (Comparative Example 12) to conduct an ILSS test. The result is indicated in both Table 12 and FIG. 16. The error bar in the figure indicates the standard deviation. The ILSS measurements of the both samples taken from the test are almost identical, verifying that the low sized (0.05 to 0.30 weight %) carbon fiber also has superb interfacial adhesion. Additionally, the ILSS of unsized fiber is also shown.

### Example 15, Comparative Example 13

Unsized 12K high tensile strength, standard modulus carbon fiber “Torayca” T700SC (Registered trademark by Toray Industries strand strength 4.9 GPa, strand modulus 230 GPa) was used. The carbon fiber was continuously submerged in the sizing bath containing 0.2 to 1.6 weight % of methylated melamine-formaldehyde resin. After the submerging process, it was dried at 220 degrees Celsius for 1 minute. The sizing amount was measured with a burn off method.

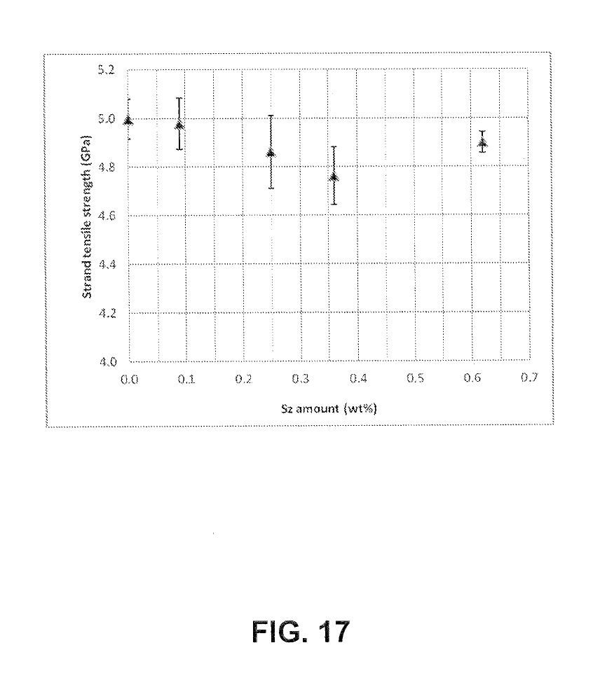

The tensile strengths of both the sizing amount of 0.05 to 0.30 weight % (Example 15) and 0.31 to 0.62 weight % (Comparative Example 13) were measured. The results are shown in both Table 13 and FIG. 17. The error bar in the figure indicates the standard deviation. Additionally, the mechanical properties of unsized fiber are also shown.

### Example 16, Comparative Example 14

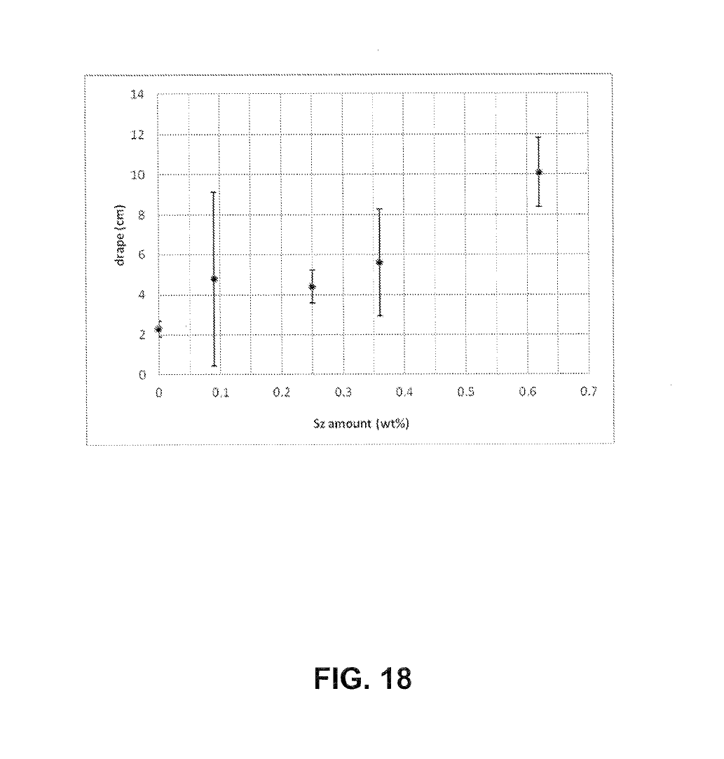

The same as the above Example 15 and Comparative Example 13, the samples were made, i.e. one with sizing amount of 0.05 to 0.30 weight % (Example 16) and the other with 0.31 to 0.62 weight % (Comparative Example 14) to test the drape value. The result is indicated in both Table 14 and FIG. 18. The error bar in the figure indicates the standard deviation. The sample of Example 16 has superior drapeability than that of Comparative Example 14. Additionally, the drape value of unsized fiber is also shown.

### Example 17, Comparative Example 15

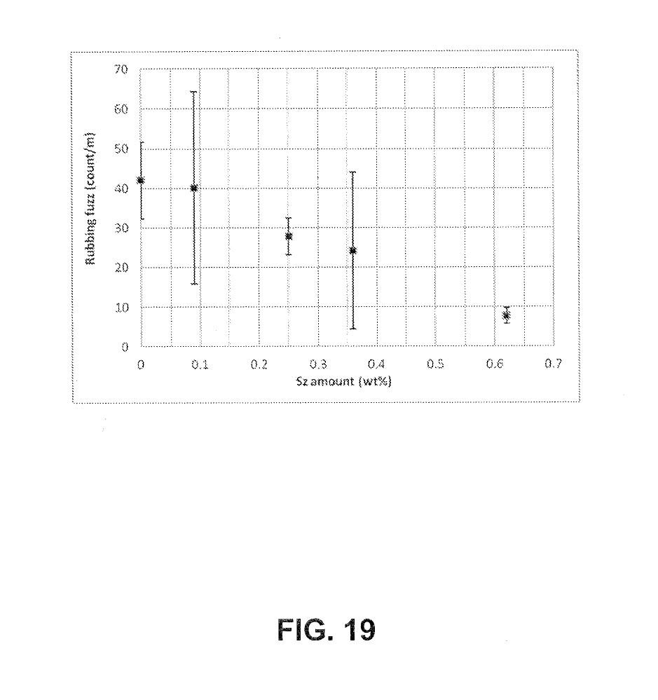

The same as the above Example 15 and Comparative Example 13, the samples were made, i.e. one with sizing amount of 0.05 to 0.30 weight % (Example 17) and the other with 0.31 to 0.62 weight % (Comparative Example 15) to conduct a fuzz count test. The result is shown in Table 15 and FIG. 19. The error bar in the figure indicates the standard deviation.

### Example 18, Comparative Example 16

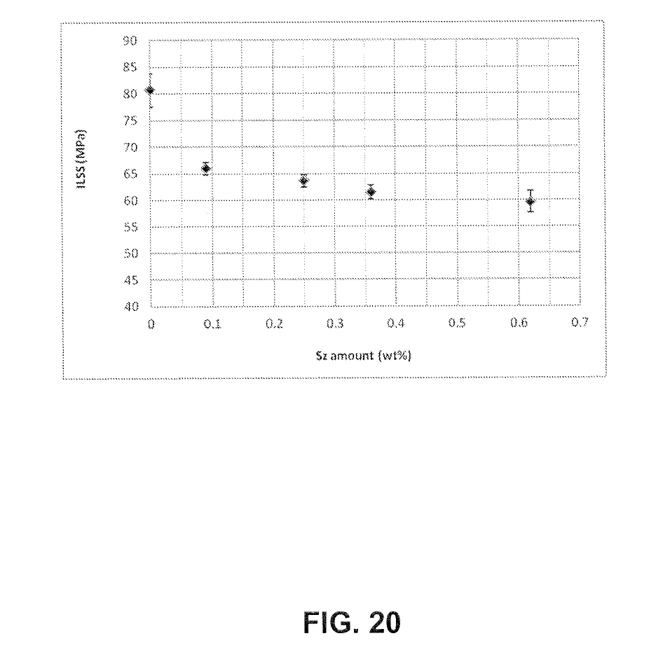

The same as the above Example 15 and Comparative Example 13, the samples were made, i.e. one with sizing amount of 0.05 to 0.30 weight % (Example 18) and the other with 0.31 to 0.62 weight % (Comparative Example 16) to conduct an ILSS test. The result is indicated in both Table 16 and FIG. 20. The error bar in the figure indicates the standard deviation. Additionally, the ILSS of unsized fiber is also shown.

### Example 19

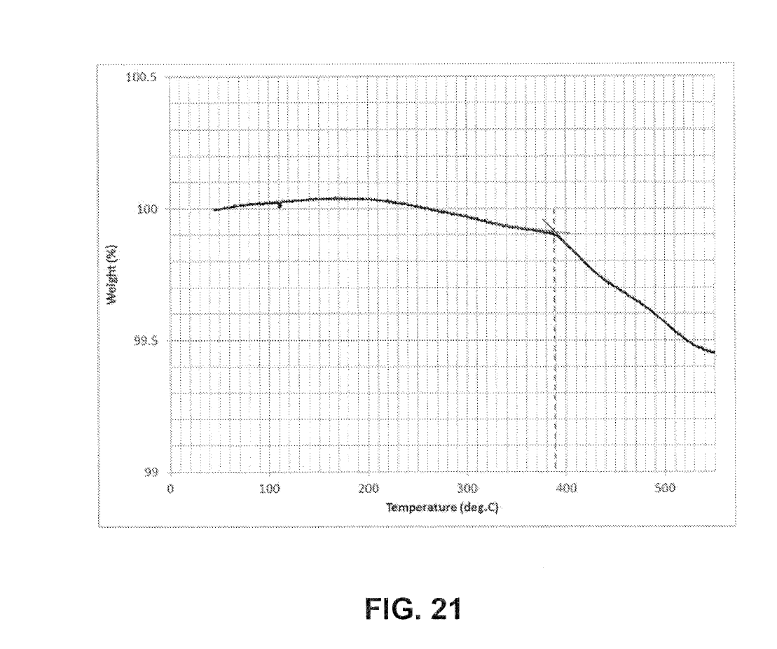

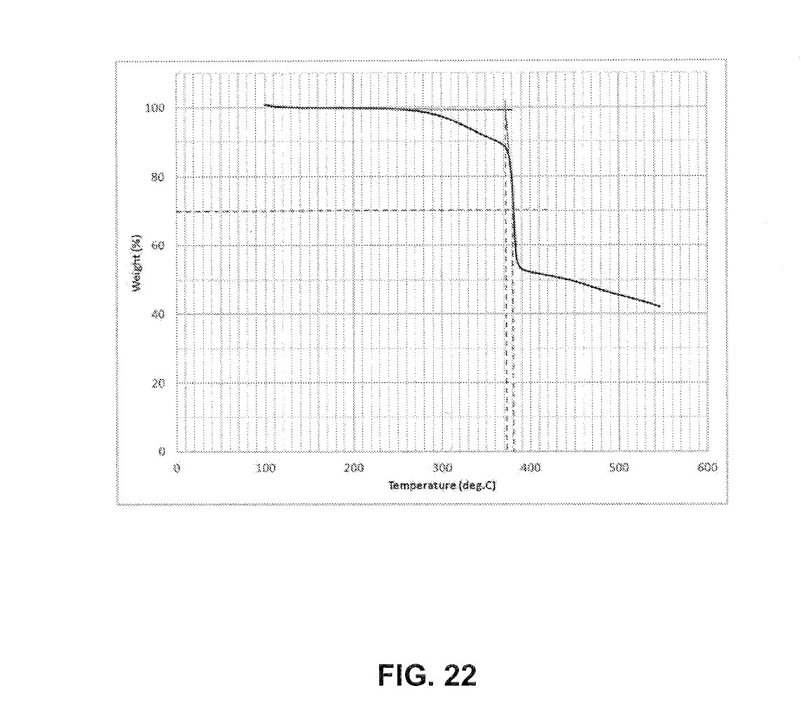

Thermogravimetric analysis (TGA) was conducted under air atmosphere. The heat degradation onset temperature of the same carbon fiber as the above Example 15 is 390 degrees Celsius as shown in FIG. 21. The heat degradation onset temperature of the sizing is 375 degrees Celsius and the 30% weight reduction temperature is 380 degrees Celsius as shown in FIG. 22, confirming the heat resistance is in excess of 350 degrees Celsius.

### Example 20, Comparative Example 17

Unsized 12K high tensile strength, standard modulus carbon fiber “Torayca” T700SC (Registered trademark by Toray Industries—strand strength 4.9 GPa, strand modulus 230 GPa) was used. The carbon fiber was continuously submerged in the sizing bath containing 0.1 to 2.0 weight % of epoxy cresol novolac resin. After the submerging process, it was dried at 220 degrees Celsius for 1 minute. The sizing amount was measured with a burn off method.

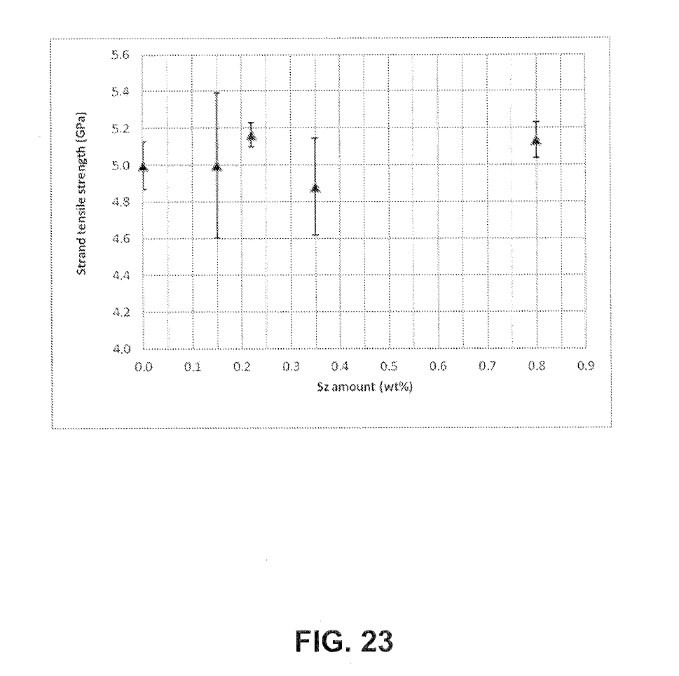

The tensile strengths of both the sizing amount of 0.05 to 0.30 weight % (Example 20) and 0.31 to 0.80 weight % (Comparative Example 17) were measured. The results are shown in both Table 17 and FIG. 23. The error bar in the figure indicates the standard deviation. Additionally, the mechanical properties of unsized fiber are also shown.

### Example 21, Comparative Example 18

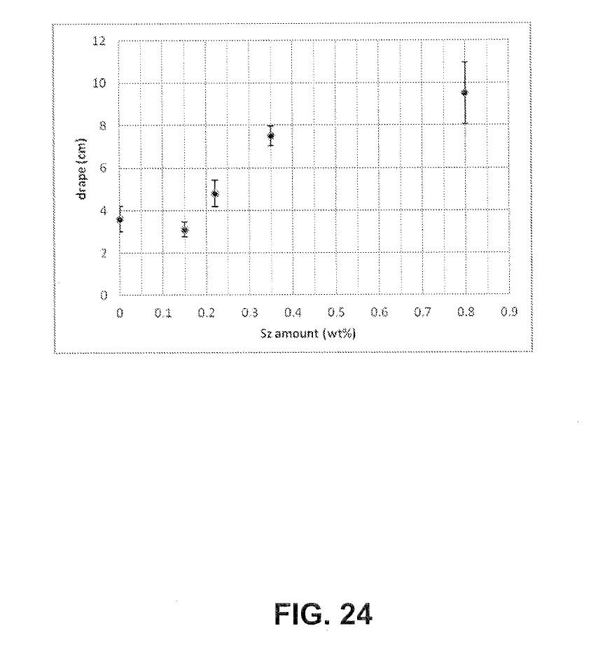

The same as the above Example 20 and Comparative Example 17, the samples were made, i.e. one with sizing amount of 0.05 to 0.30 weight % (Example 21) and the other with 0.31 to 0.80 weight % (Comparative Example 18) to test the drape value. The result is indicated in both Table 18 and FIG. 24. The error bar in the figure indicates the standard deviation. The sample of Example 21 has superior drapeability than that of Comparative Example 18. Additionally, the drape value of unsized fiber is also shown.

### Example 22, Comparative Example 19

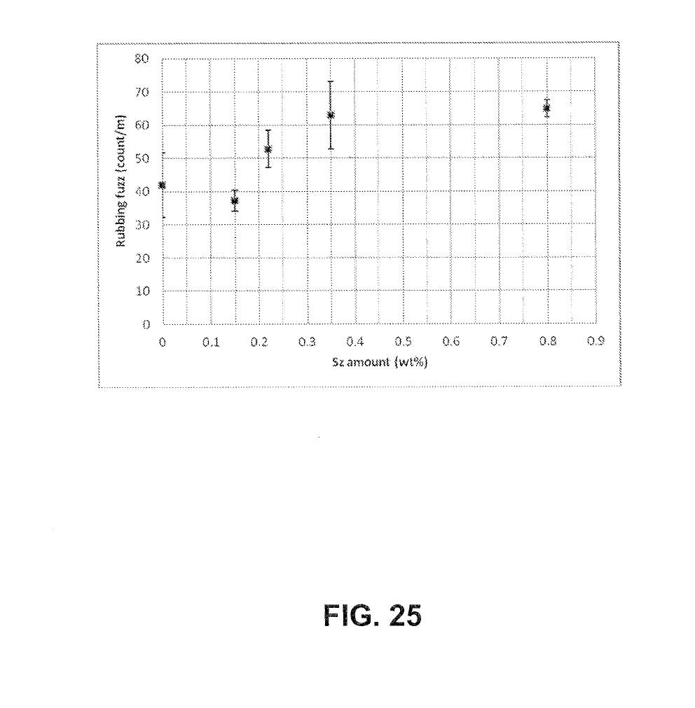

The same as the above Example 20 and Comparative Example 17, the samples were made, i.e. one with sizing amount of 0.05 to 0.30 weight % (Example 22) and the other with 0.31 to 0.80 weight % (Comparative Example 19) to conduct a fuzz count test. The result is shown in Table 19 and FIG. 25. The error bar in the figure indicates the standard deviation.

### Example 23, Comparative Example 20

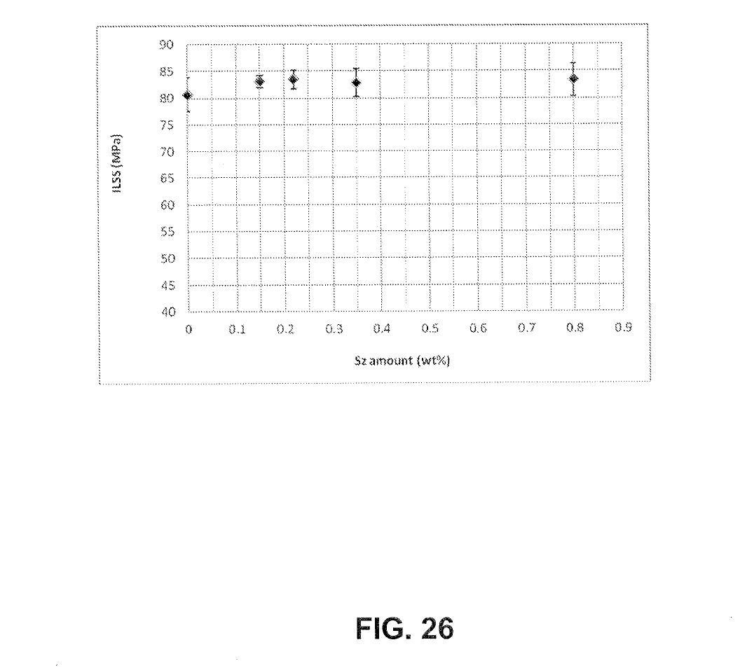

The same as the above Example 20 and Comparative Example 17, the samples were made, i.e. one with sizing amount of 0.05 to 0.30 weight % (Example 23) and the other with 0.31 to 0.80 weight % (Comparative Example 20) to conduct an ILSS test. The result is indicated in both Table 20 and FIG. 26. The error bar in the figure indicates the standard deviation. The ILSS measurements of the both samples taken from the test are almost identical, verifying that the low sized (0.05 to 0.30 weight %) carbon fiber also has superb interfacial adhesion. Additionally, the ILSS of unsized fiber is also shown.

### Example 24

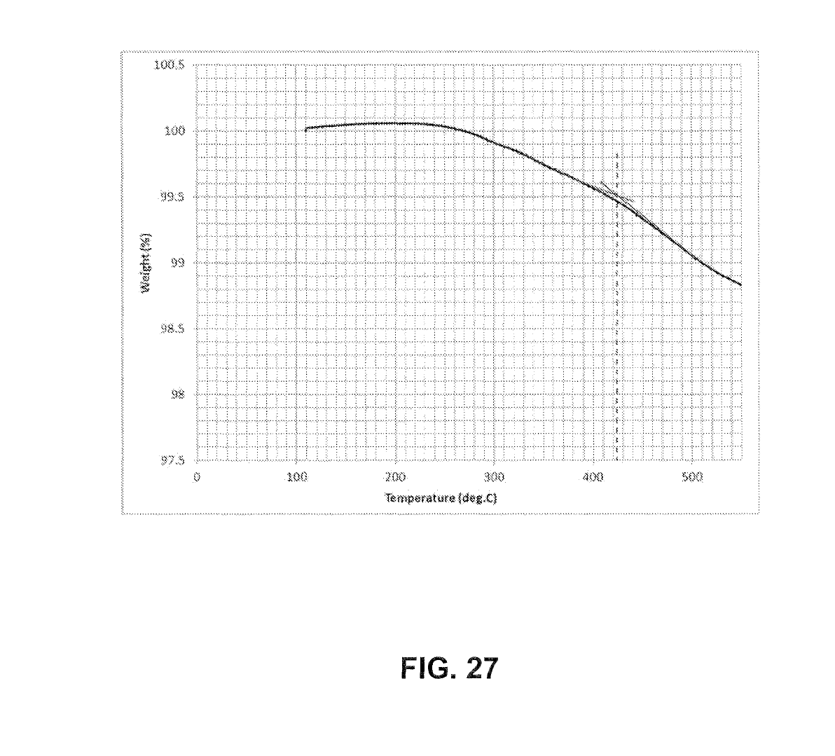

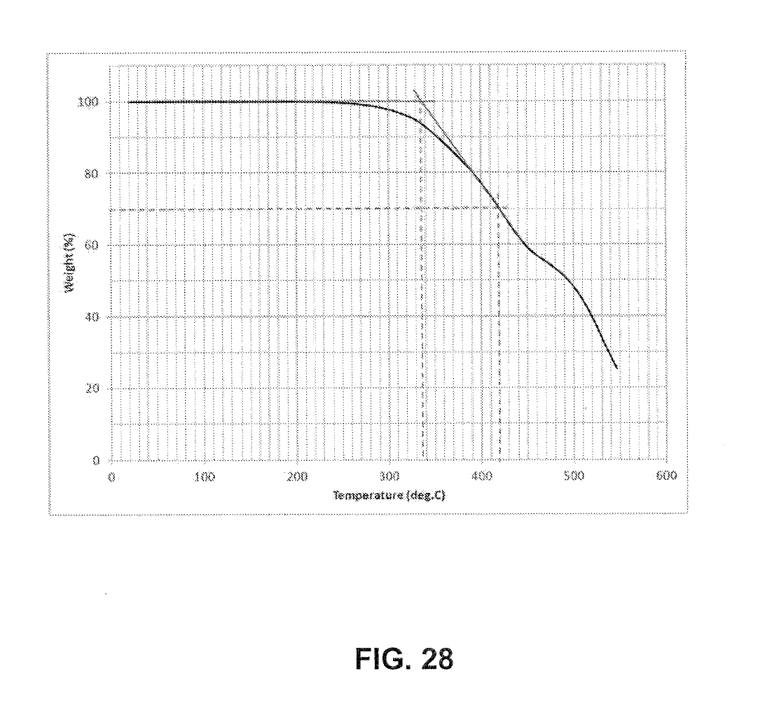

Thermogravimetric analysis (TGA) was conducted under air atmosphere. The heat degradation onset temperature of the same carbon fiber as the above Example 20 is 423 degrees Celsius as shown in FIG. 27. The heat degradation onset temperature of the sizing is 335 degrees Celsius and the 30% weight reduction temperature is 420 degrees Celsius as shown in FIG. 28, confirming the heat resistance is in excess of 300 degrees Celsius.

### Example 25, Comparative Example 21, 22

As indicated in Examples 11 the carbon fiber with about 0.2 weight % heat resistant sizing (Examples 25), “Torayca” T700SC-12K-60E and Unsized fiber T700SC-12K (Comparative Examples 21, 22) were used.

Unidirectional specimens were obtained by stacking thermoplastic tapes made of carbon fiber strand and PPS resin. In accordance with EN2850 Standard Test Method for “Compression Test Parallel to the Fibre Direction on Carbon Fibre Reinforced Plastics”, the compression tests were conducted. As a result, as indicated in Table 21, Example 25 is superior to the Comparative Examples 21 and 22.

### Example 26, 27, Comparative Example 23, 24

As indicated in Examples 1 and 6 the carbon fiber with about 0.2 weight % heat resistant sizing (Example 26, 27), “Torayca” T800SC-24K-10E and Unsized fiber T800SC-24K (Comparative Examples 23, 24) were used.

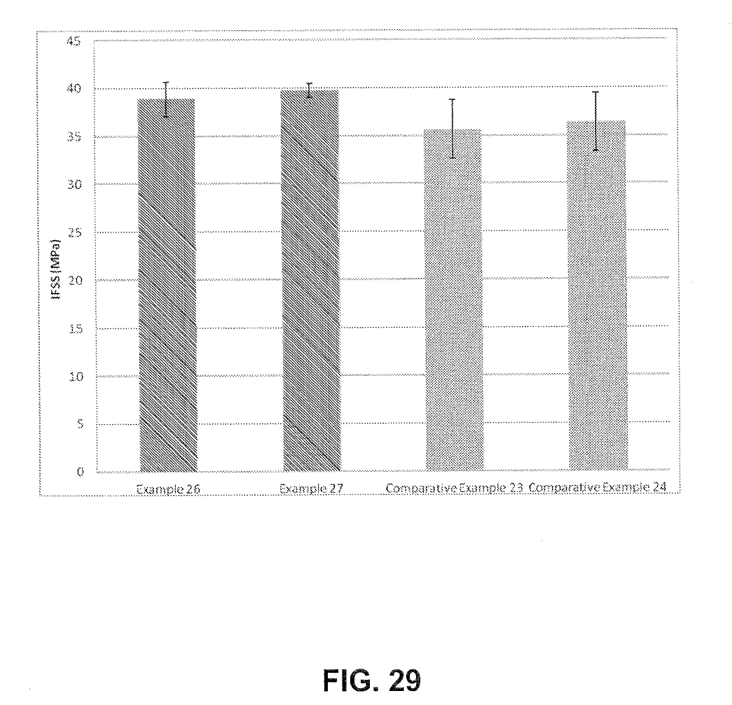

FIG. 29 and Table 22 show the results of SFFT using polyetherimide resin. From the results, it can be shown the IFSS of Example 26 and 27 are over 5% higher than that of Comparative Example 23 and 24.

### Example 28, 29, 30, Comparative Example 25

As indicated in Examples 11, 15 and 20 the carbon fiber with about 0.2 weight % heat resistant sizing (Examples 28, 29, 30) and Unsized fiber T700SC-12K (Comparative Examples 25) were used.

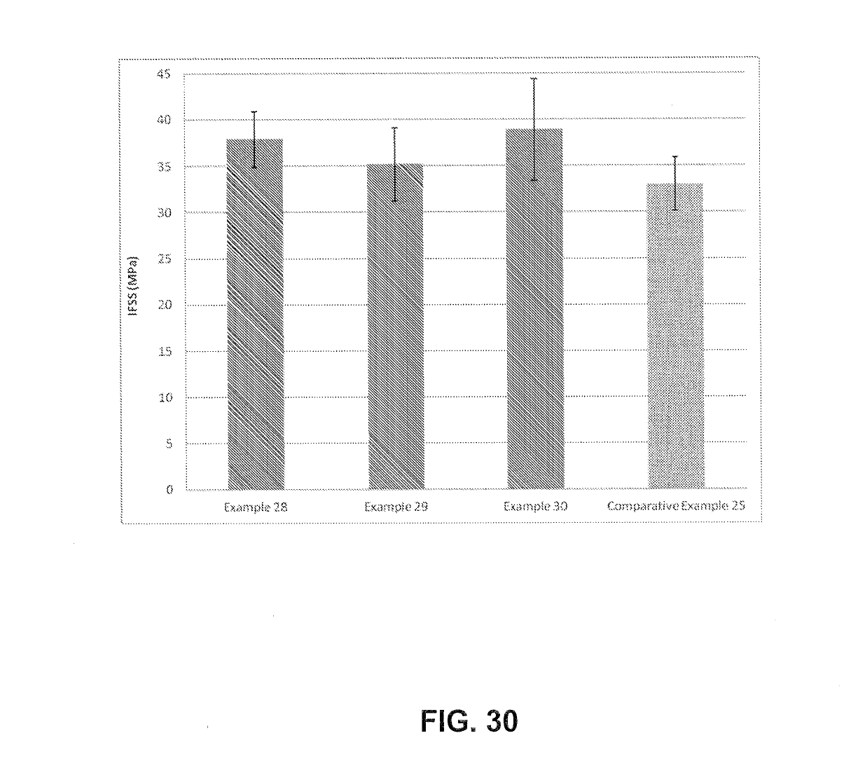

FIG. 30 and Table 23 show the results of SFFT using polyetherimide resin. It can be shown the IFSS of Example 28 through 30 are over 5% higher than that of Comparative Example 25 and the IFSS of Example 28 and 30 are over 100 higher than that of Comparative Example 25.

While the invention has been explained with reference to the specific embodiments of the invention, the explanation is illustrative and the invention is limited only by the appended claims.

What is claimed is:

1. A method of making a carbon fiber structure comprising:
applying a sizing solution containing a polyamic acid and a solvent to a carbon fiber, and thereafter,
heating the carbon fiber for a period of time whereby the polyamic acid is imidized on the carbon fiber to form a coating.

2. The method according to claim 1 wherein the solvent is a dimethylaminoethanol salt water solution.

3. The method according to claim 1 wherein the sizing solution contains 0.05-2.0 weight % of polyamic acid.

4. The method according to claim 1 wherein the polyamic acid includes monomers of 2,2′-Bis(4-(3,4-dicarboxyphenol)phenyl) propane dianhydride and meta-phenylene diamine.

5. The method according to claim 1 wherein the imidization occurs within the range of 280 degree Celsius to 330 degree Celsius.

6. The method according to claim 1 wherein the imidization occurs within the range of 200 degree Celsius to 450 degree Celsius.

7. The method according to claim 1 wherein the coating is selected from the group consisting of a polyetherimide coating and a polyimide coating.

8. The method according to claim 1 wherein coating is present in an amount X between 0.05 and 0.3 wt %, the amount X being expressed with a following formula:
$$X = \frac{{w}_{0} - {w}_{1}}{{w}_{0}} \times 100$$
where W₀ is a weight of the carbon fiber with the coating, and W₁ is a weight of the carbon fiber without the coating.

9. The method according to claim 1 wherein the coating exhibits an imidization ratio in an amount X, the amount X being 80% or more and expressed with a following formula:
X(%)−(1−D/C)×100
where a weight loss ratio C of the polyamic acid without being imidized and a weight loss ratio D of a polyimide are measured between 130 degree Celsius and 415 degree Celsius under air atmosphere with TGA, holding 110 degree Celsius for 2 hours, then heating up to 450 degree Celsius at 10 degree Celsius/min.

10. The method according to claim 1 wherein the coating exhibits an imidization ratio in an amount X, the amount X being 95% or more and expressed with a following formula:
X(%)−(1−D/C)×100
where a weight loss ratio C of the polyamic acid without being imidized and a weight loss ratio D of a polyimide are measured between 130 degree Celsius and 415 degree Celsius under air atmosphere with TGA, holding 110 degree Celsius for 2 hours, then heating up to 450 degree Celsius at 10 degree Celsius/min.

11. The method according to claim 1 wherein the period of time is within the range of 6 seconds to 15 minutes.

12. The method according to claim 1 wherein the period of time is about 1 minute.

13. The method according to claim 1 further comprising braiding the carbon fiber.

14. The method according to claim 1 further comprising forming a mat with the carbon fiber.

15. The method according to claim 1 further comprising impregnating the carbon fiber with a thermoplastic resin and forming a thermoplastic impregnated carbon fiber therefrom.

16. The method according to claim 15 further comprising forming a tape with the thermoplastic impregnated carbon fiber.

17. The method according to claim 15 wherein the carbon fiber exhibits an imidization ratio of at least 80% immediately before impregnation thereof with the thermoplastic resin.

18. The method according to claim 1 further comprising combining the carbon fiber with a thermoplastic fiber and forming a thermoplastic molding preform therefrom.

18. A method of making a carbon fiber structure comprising:
applying a sizing solution containing 0.05-2.0 weight % of a polyamic acid to a carbon fiber, followed by,
heating the carbon fiber at 280 degree Celsius to 330 degree Celsius for a period of 6 seconds to 15 minutes whereby the polyamic acid is imidized on the carbon fiber to form a coating, the coating exhibiting an imidization ratio in an amount X, the amount X being 80% or more and expressed with a following formula:
X(%)−(1−D/C)×100
where a weight loss ratio C of the polyamic acid without being imidized and a weight loss ratio D of a polyimide are measured between 130 degree Celsius and 415 degree Celsius under air atmosphere with TGA, holding 110 degree Celsius for 2 hours, then heating up to 450 degree Celsius at 10 degree Celsius/min, followed by,
incorporating the carbon fiber within a composite.

19. The method according to claim 18 wherein incorporating the carbon fiber into the composite includes impregnating the carbon fiber with a thermoplastic resin.

20. A method of making a carbon fiber structure comprising:
applying a polyamic acid to a carbon fiber,
heating the carbon fiber at 200 degree Celsius to 450 degree Celsius whereby the polyamic acid is imidized on the carbon fiber to form a coating, and
impregnating the carbon fiber with a thermoplastic resin after the polyamic acid exhibits an imidization ratio in the coating in an amount X, the amount X being 80% or more and expressed with a following formula:
X(%)−(1−D/C)×100
where a weight loss ratio C of the polyamic acid without being imidized and a weight loss ratio D of a polyimide are measured between 130 degree Celsius and 415 degree Celsius under air atmosphere with TGA, holding 110 degree Celsius for 2 hours, then heating up to 450 degree Celsius at 10 degree Celsius/min.
